(19) United States
(12) Patent Application Publication
(10) Pub. No.: US 2026/0278113 A1
(43) Pub. Date: Sep. 17, 2026

(54) FUZZ TESTING ARCHITECTURE GENERATION FOR COMPUTING SYSTEMS AND APPLICATIONS

(71) Applicant: NVIDIA Corporation, Santa Clara, CA (US)

(72) Inventors: Maksym BAZALII, Timnath, CO (US); Thomas Michael MCREYNOLDS, Los Altos Hills, CA (US)

(21) Appl. No.: 19/080,559

(22) Filed: Mar. 14, 2025

(51) Int. Cl. G06F 21/57; G06F 11/3604; G06F 11/3698

(52) U.S. Cl. CPC G06F 21/577; G06F 11/3608; G06F 11/3698; G06F 2221/033

(57) ABSTRACT

Embodiments of the present disclosure relate to applications, platforms, architecture, etc. for fuzz testing of software programs. In particular, one or more generative language model (GLM) prompts related to generation of a fuzz test harness may be generated. Based on such prompts, a GLM may be able to automatically generate the fuzz test harness, which may then be executed for performance of fuzz testing.

### BACKGROUND

Modern software programs have become increasingly complex, often containing millions of lines of code. As a result, ensuring the reliability and security of such software programs is critical. Software testing methodologies play an essential role in identifying bugs, vulnerabilities, and unintended behaviors before deployment. One such testing technique is known as “fuzzing.”

Fuzzing is a dynamic testing process in which a software program is repeatedly executed with a large number of automatically generated inputs in an attempt to identify potential security vulnerabilities, software crashes, or unexpected behaviors. These inputs, often referred to as “test cases” or “fuzzed inputs,” are typically malformed or randomly mutated to explore edge cases and code paths that may not be exercised during conventional testing.

Fuzzing has proven to be an effective method for discovering vulnerabilities such as memory corruption errors, buffer overflows, and use-after-free conditions. However, the inherent randomness of the inputs, along with the vast potential input space, can result in inefficiencies, as many test cases may not trigger meaningful execution paths. As a result, there remains a need for improvements to fuzzing techniques, particularly in the areas of input generation, test case prioritization, and feedback mechanisms to improve the coverage and efficiency of the testing process.

For example, an important component of effective fuzz testing is a fuzzing test harness (“test harness”.) A test harness may include a program or environment designed to interface with a fuzzing system (“fuzzer”) and a target software program under test, allowing the fuzzer to generate and input test cases while monitoring the software program's behavior.

By automating the input generation, execution, and monitoring processes, test harnesses enable large-scale, continuous testing of software applications. An effective test harness is helpful for achieving comprehensive code coverage and identifying critical vulnerabilities that might not be exposed through traditional testing methods. However, the process of generating test harnesses can be a labor intensive and manual process that not only may require many programmer resources, but that may also be prone to user oversights and errors.

### SUMMARY

Embodiments of the present disclosure relate to fuzz testing architecture generation for computing systems and applications. Systems and methods are disclosed that automate one or more aspects of generating fuzzing test harnesses (“test harnesses”). For example, one or more generative language model (GLM) prompts related to fuzz testing of a software program may be generated. The GLM prompts may be configured to cause a GLM (e.g., a large language model (LLM), a vision language model (VLM), a multi-modal language model (MMLM), a transformer model, etc.) to identify one or more functions of the software program to fuzz test. Additionally or alternatively, the GLM prompts may be configured to cause the GLM to generate a test harness that includes fuzzing source code configured to execute the fuzz testing of the functions of the software program as identified. In these and other embodiments, the test harness may be generated by providing the GLM prompts to the GLM such that the GLM may produce the test harness. In these and other embodiments, the software program may be fuzz tested using the generated test harness.

In some embodiments, performance of the fuzzing performed based on the test harness may be determined. In these and other embodiments, one or more additional GLM prompts may be generated based on the determined performance. The additional GLM prompts may be configured to cause the GLM to modify one or more aspects of the test harness based on one or more performance metrics corresponding to the determined performance. The software program may then be fuzz tested again based on execution of the modified test harness. In these and other embodiments, the process of fuzzing based on the test harness, determining the performance of the fuzzing, and modifying the test harness through updated GLM prompts may be repeated until one or more performance metrics are satisfied. Therefore, the GLM may be enabled to perform one or more aspects of the test harness generation process that may traditionally be performed manually.

In contrast to conventional systems, the systems and methods of the present disclosure may provide a significant improvement in the field of software fuzzing. In particular, the automation of the generation of the fuzzing test harness may significantly reduce the amount of time needed to generate and implement a fuzzing test harness, perform fuzzing, modify the test harness based on fuzzing results, etc. Further, the embodiments help improve the functionality of computing systems themselves by providing a specific mechanism and series of steps and operations that allow for computing systems to be able to automatically generate test harnesses.

### BRIEF DESCRIPTION OF THE DRAWINGS

The present systems and methods for fuzz testing architecture generation for computing systems and applications are described in detail below with reference to the attached drawing figures, wherein:

FIG. 1 illustrates an example system related to fuzz testing software programs, in accordance with at least some embodiments of the present disclosure;

FIG. 2 illustrates an example process for generating fuzz testing architecture, in accordance with at least some embodiments of the present disclosure;

FIG. 3 illustrates an example target function identification process, in accordance with at least some embodiments of the present disclosure;

FIG. 4 illustrates an example test harness generation process, in accordance with at least some embodiments of the present disclosure;

FIG. 5 illustrates an example repair patch generation process, in accordance with at least some embodiments of the present disclosure;

FIG. 6 is a flow diagram showing a method for generating a fuzz testing architecture for a software program, in accordance with at least some embodiments of the present disclosure;

FIG. 7A is a block diagram of an example generative language model (LM), in accordance with at least some embodiments of the present disclosure;

FIG. 7B is a block diagram of an example implementation in which the generative LM of FIG. 7A includes a transformer encoder-decoder, in accordance with at least some embodiments of the present disclosure;

FIG. 7C is a block diagram of an example implementation in which the generative LM of FIG. 7A includes a decoder-only transformer architecture, in accordance with at least some embodiments of the present disclosure;

FIG. 8 is a block diagram of an example computing device, in accordance with at least some embodiments of the present disclosure;

FIG. 9 is a block diagram of an example data center, in accordance with at least some embodiments of the present disclosure;

FIG. 10A is an example of sensor locations having corresponding fields of view or sensory fields for example autonomous or semi-autonomous machines, in accordance with at least some embodiments of the present disclosure;

FIG. 10B is an illustration of an example of component and sensor locations on an autonomous or semi-autonomous vehicle, in accordance with at least some embodiments of the present disclosure;

FIG. 10C is a block diagram of an example system architecture for an autonomous or semi-autonomous vehicle, robot, and/or other machine type, in accordance with at least some embodiments of the present disclosure;

FIG. 10D is a block diagram of an example architecture of a computing system-such as a system-on-a-chip (SoC)—in accordance with at least some embodiments of the present disclosure;

FIG. 10E is a system diagram for communication between cloud-based server(s) and an example autonomous or semi-autonomous vehicle, robot, and/or other machine type, in accordance with at least some embodiments of the present disclosure;

FIG. 10F is an example of camera locations and fields of view for an example autonomous vehicle, in accordance with at least some embodiments of the present disclosure; and

FIG. 11 is a system diagram illustrating a three-computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure.

### DETAILED DESCRIPTION

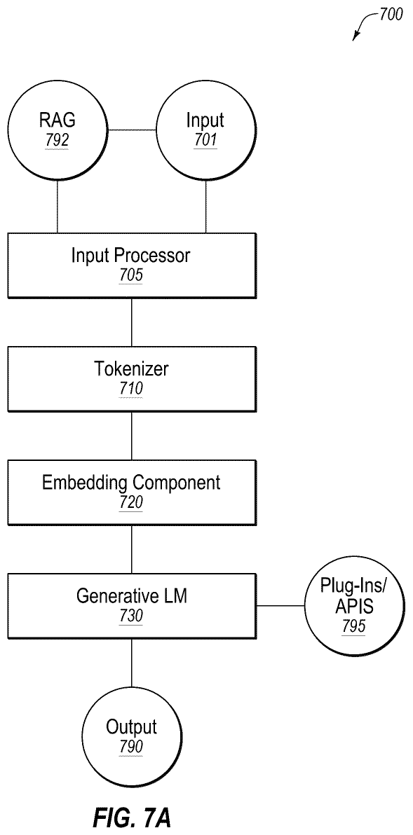

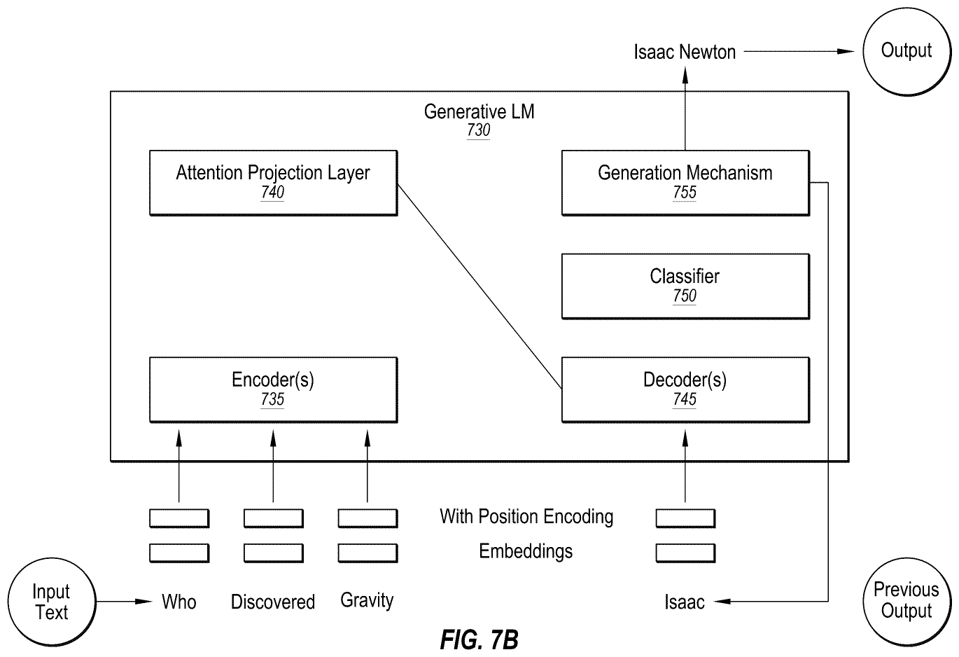

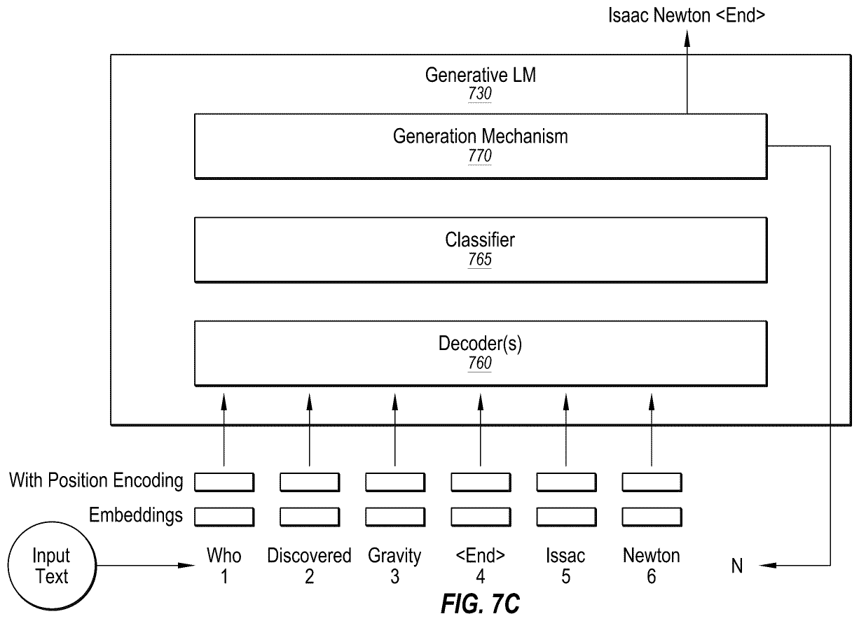

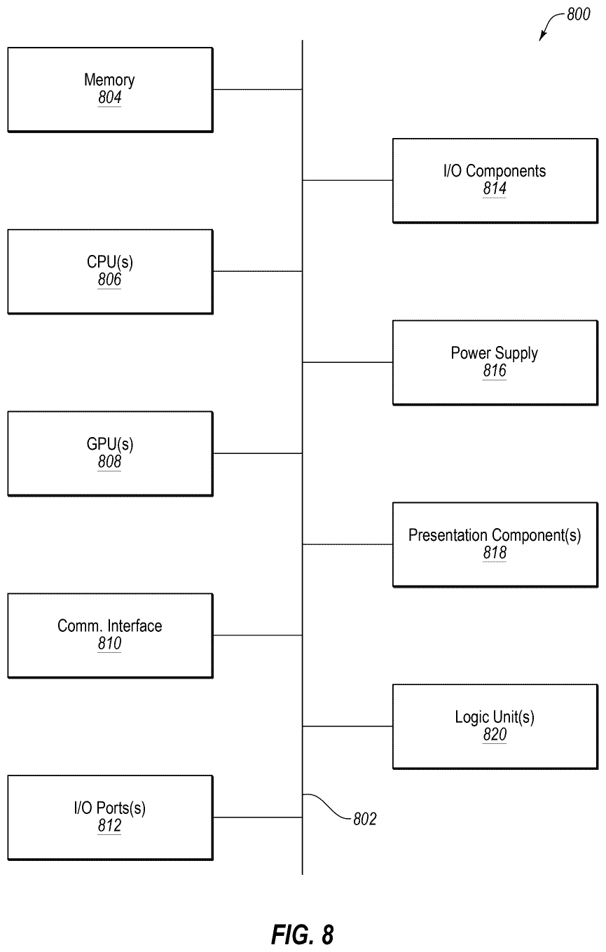

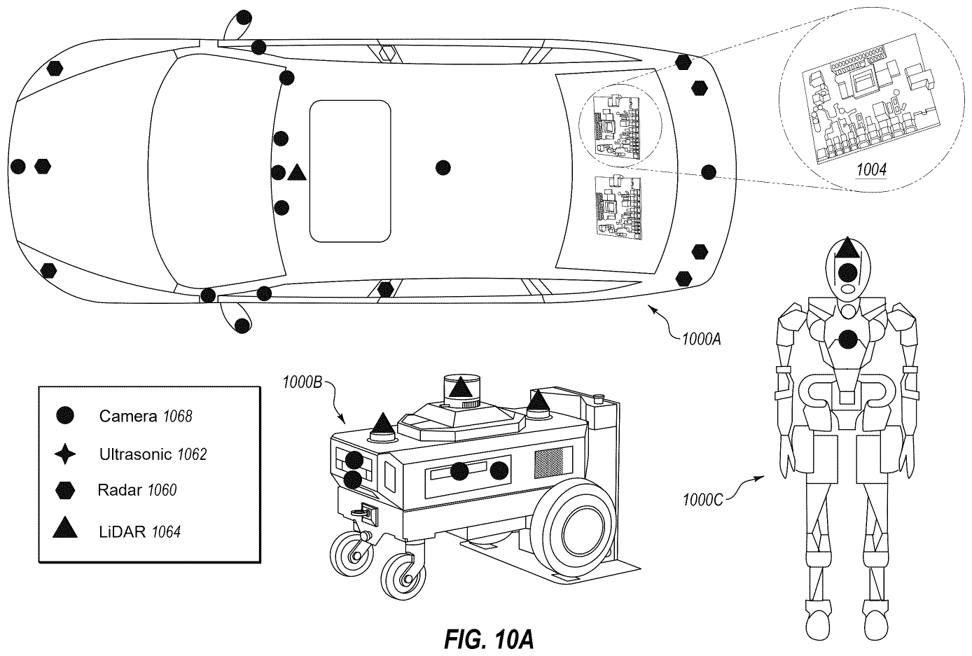

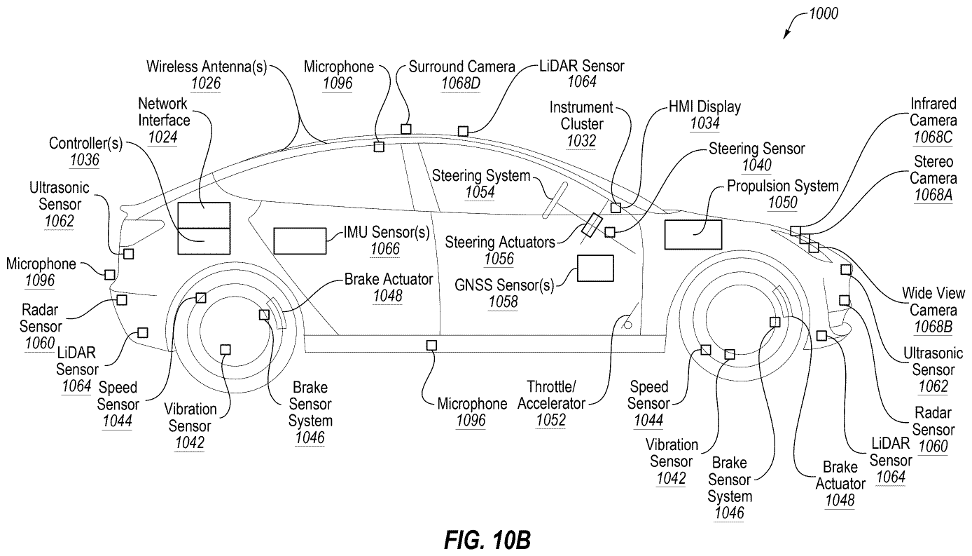

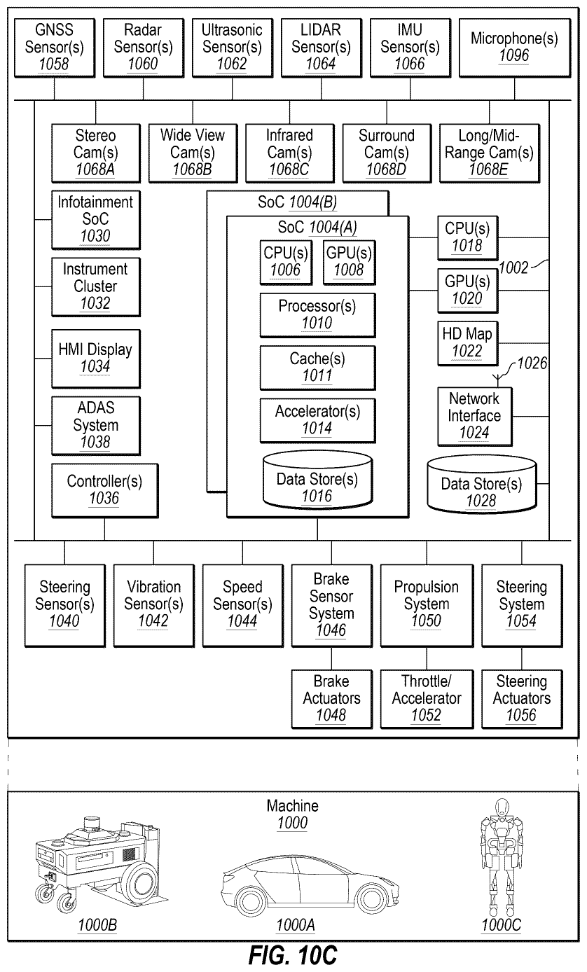

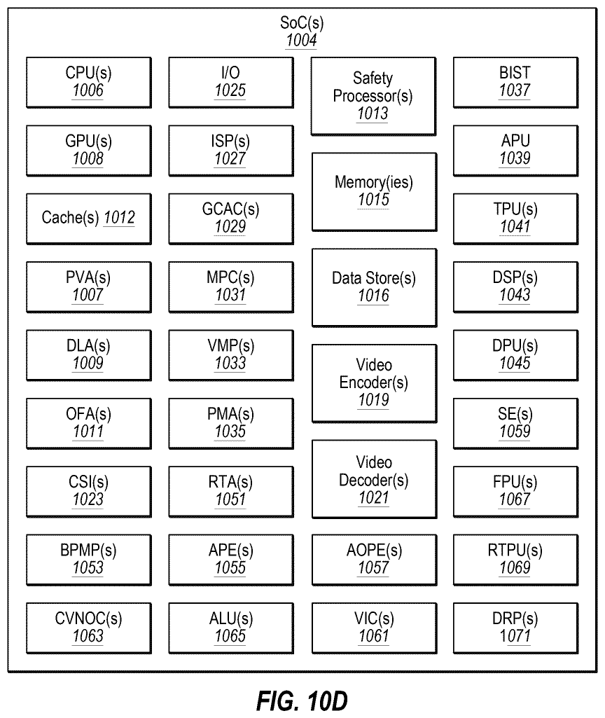

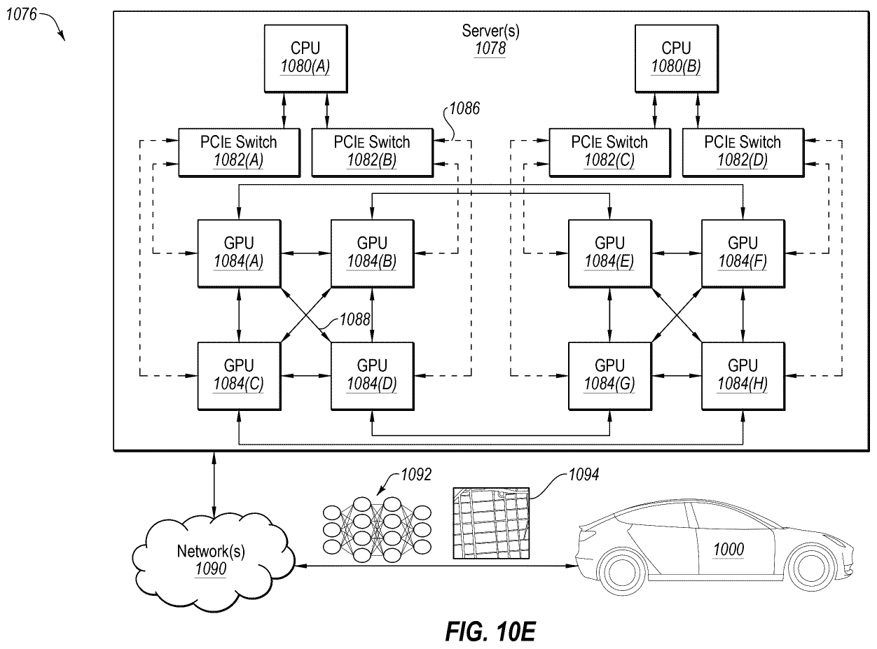

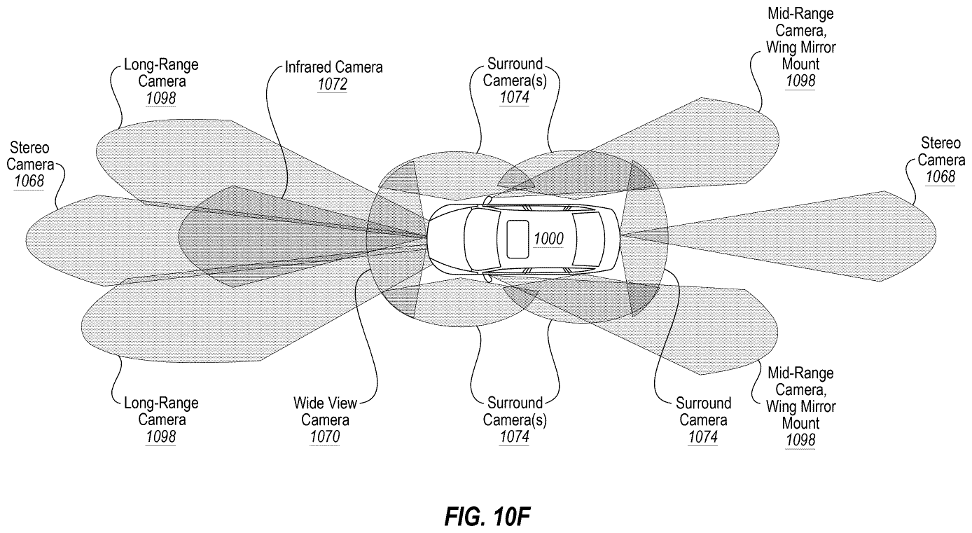

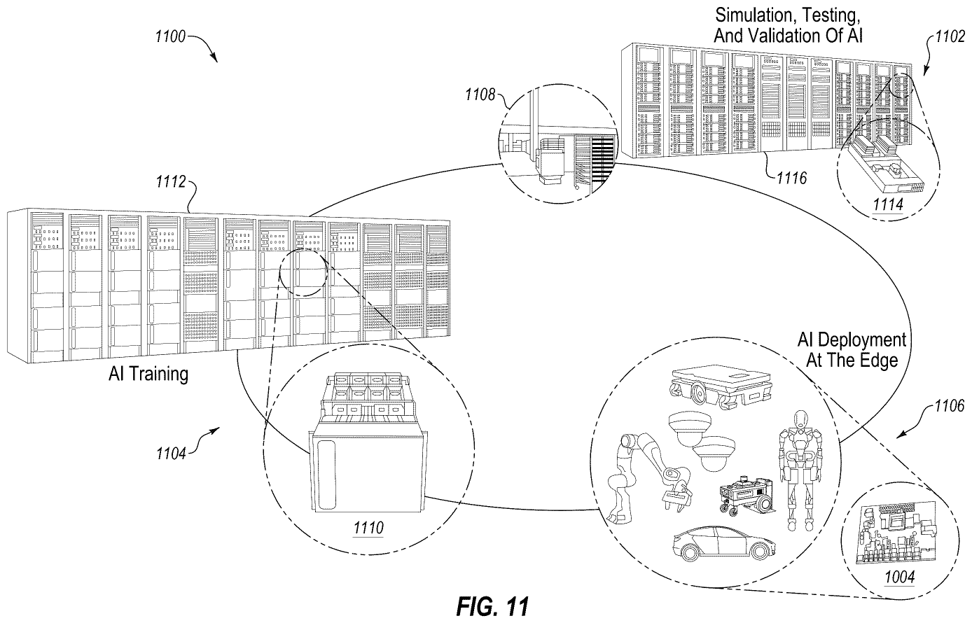

Systems and methods are disclosed related to fuzz testing architecture generation for computing systems and applications. Although the present disclosure may be described with respect to an example autonomous or semi-autonomous vehicle, robot, and/or other machine type 1000 (alternatively referred to herein as “vehicle 1000,” “ego-vehicle 1000,” “machine 1000,” “ego-machine 1000,” “robot 1000,” and/or “ego-robot 1000,” an example of which is described with respect to FIGS. 10A-10F), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors), warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to autonomous driving, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where fuzz testing may be used. In some embodiments, the systems, methods, and/or processes described herein may be executed using similar components, features, and/or functionality to those of example machine 1000 of FIGS. 10A-10F, example computing ecosystem 1100 of FIG. 11, example generative language model system 700 of FIG. 7A, and/or example computing device 800 of FIG. 8.

In particular, the present disclosure relates to creating a mechanism in which generative language models (GLMs) may be used to generate fuzzing test harnesses (“test harnesses”) for fuzzing software programs. For example, as discussed in detail in the present disclosure, one or more embodiments may be configured to generate prompts for GLMs in which the prompts are used by the GLMs to generate the test harnesses.

In some embodiments, the prompts may be generated such that a GLM is able to identify which portions of the software programs (e.g., functions) may be good targets for fuzzing. Additionally or alternatively, the prompts may be generated such that the GLM is able to identify various characteristics about the identified functions that are useful in generating a test harness. For example, the prompts may be such that the GLM identifies dependencies between functions, types of input arguments for the functions, and/or return values for the functions. In these and other embodiments, the prompts may be generated such that the GLM generates a test harness for the software program based on the identified functions and corresponding function characteristics.

In some embodiments, one or more operations may also include the generation of seed inputs that may be used as initial inputs to the generated test harness to begin the fuzz testing through the execution of the test harness. Additionally or alternatively, the operations may include determining one or more performance metrics related to the fuzzing performed based on the test harness. In these and other embodiments, one or more additional GLM prompts may be generated based on the determined performance. The additional GLM prompts may be configured to cause the GLM to modify one or more aspects of the test harness based on one or more performance metrics corresponding to the determined performance. The software program may then be fuzz tested again based on execution of the modified test harness. In these and other embodiments, the process of fuzzing based on the test harness, determining the performance of the fuzzing, and modifying the test harness through updated GLM prompts may be repeated until one or more fuzzing performance metrics are satisfied.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to determine applications, platforms, architecture, etc. for fuzz testing of software programs. In particular, one or more generative language model (GLM) prompts related to generation of a fuzz test harness may be generated, and based on such prompts, a GLM may be able to automatically generate a fuzz test harness, which may then be executed for performance of fuzz testing. Such information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data from within the simulation. The synthetic training data (in addition to or alternatively from real-world data) may then be used or processed to perform fuzz testing of software.

In any example, such as where a simulation environment is used for testing, validation, training, etc., the simulation environment and/or associated training data may be rendered or otherwise generated using one or more light transport simulation algorithms-such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems-such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used to fuzz test software that may be included in a visualization or mapping of an environment to aid a remote operator in controlling- or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAS, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice-such an inference microservice (e.g., NVIDIA NIMs)—which may include a container (e.g., an operating system (OS)—level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models-such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

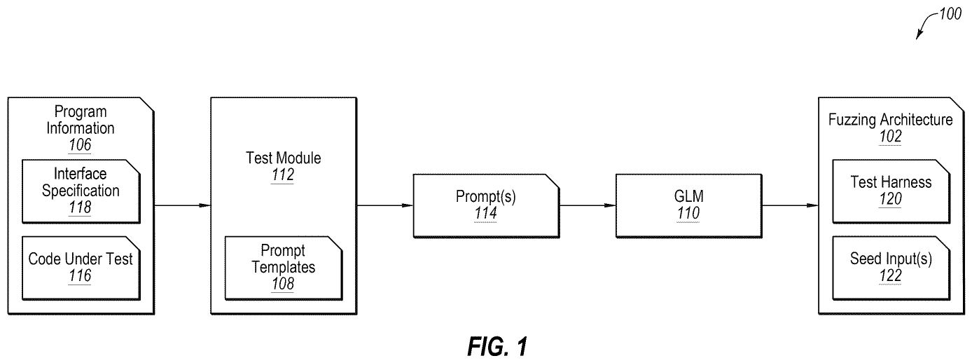

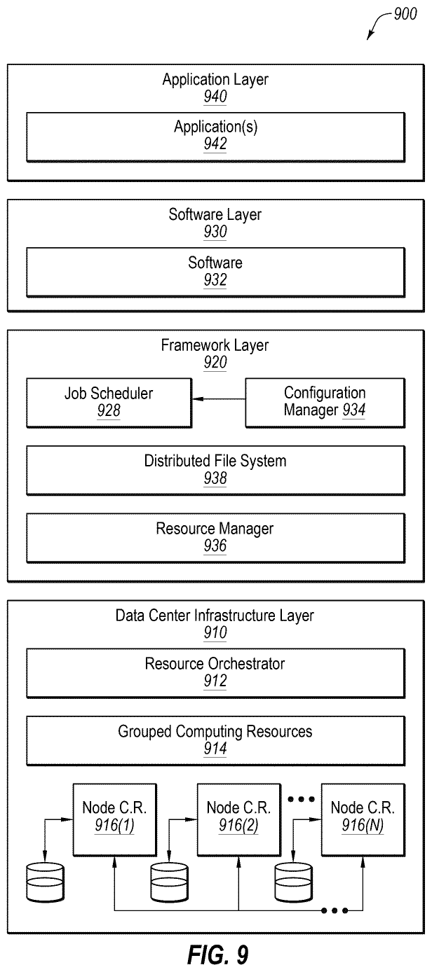

With reference to FIG. 1, FIG. 1 illustrates an example system 100 related to fuzz testing software programs, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various operations described herein as being performed by entities may be carried out by hardware, firmware, and/or software. For instance, various operations may be carried out by a processor executing instructions stored in memory. For example, in some embodiments, the system and methods described herein may be implemented using one or more generative language models (e.g., as described in FIGS. 7A-7C), one or more computing devices (e.g., as described in FIG. 8), and/or one or more data centers (e.g., as described in FIG. 9).

In general, the system 100 may be configured to use a generative language model (GLM) 110 to generate a fuzz testing architecture 102 (“fuzzing architecture 102”) for a software program. The software program may include any type of software and/or collection of software that may be configured to perform operations. In some embodiments, the software program may be considered a software system that may include multiple different types of software programs and/or software modules. For example, in some embodiments, the software program may include an operating system and/or one or more software programs that are being run on the operating system. In the present disclosure, a software program that is targeted for fuzzing may also be referred to as “the target software”, the “target software program”, or the “target program.”

The GLM 110 may include any suitable model that may be configured to generate language, such as a large language model (LLM), vision language model (VLM), or any other suitable model. In some embodiments, the generative language model described with respect to FIGS. 7A-7C may be an example of the GLM 110.

In these and other embodiments, the system 100 may include a test module 112. In some embodiments, the test module 112 may include code and routines configured to cause performance of the operations described with respect to the test module 112. Additionally or alternatively, the test module 112 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), one or more programmable vision accelerators (PVAs), which may include one or more vector processing units (VPUs), one or more direct memory access (DMA) systems, one or more pixel processing engines (PPEs), etc., and/or other processor types. In these and other embodiments, the test module 112 may be implemented using a combination of hardware and software. In the present disclosure, operations described as being performed by the test module 112 may include operations that the test module 112 may perform itself or cause to be performed by another device. In some embodiments, the test module 112 may be implemented using one or more generative language models (e.g., as described in FIGS. 7A-7C), one or more computing devices (e.g., as described in FIG. 8), and/or one or more data centers (e.g., as described in FIG. 9).

The test module 112 may be configured to interact with the GLM 110 to help in the generation of the fuzzing architecture 102. For example, the test module 112 may be configured to generate one or more prompts 114 that may be provided to the GLM 110.

In general, the prompts 114 may include a set of instructions given to the GLM 110, which may guide a response of the GLM 110 and/or be used by the GLM 110 to generate text based on the content of the prompts 114. The prompts 114 may include specific information, context, questions or tasks, commands, and/or examples that the GLM 110 may use to produce a relevant output. In these and other embodiments, some elements of the prompts 114 may include context, instructions, questions or tasks, and/or examples.

The context may include background information or setting information that provides a framework for the response. The commands may include instructions or directives as to what the GLM 110 is supposed to do, such as answering a question, generating text, or completing a sentence. The questions/tasks may include queries or tasks that the model is asked to address. Further, the examples may include examples regarding expected outputs such as an expected format and/or style of the output.

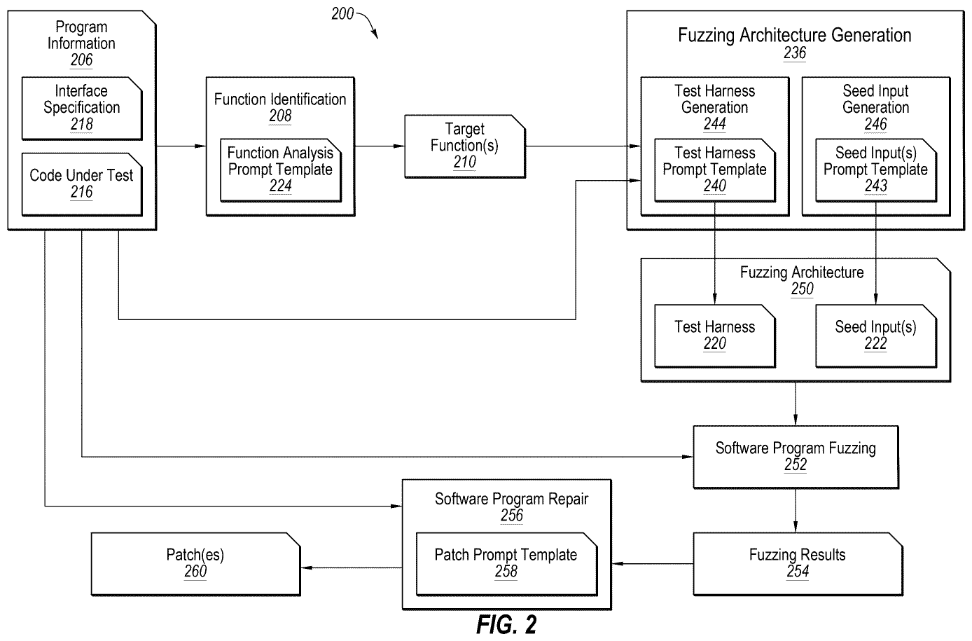

As discussed in further detail and in the context of the present disclosure, in some embodiments, the prompts 114 may be used to obtain information from the GLM 110 for the generation of the fuzzing architecture 102. For example, the prompts 114 may include specific context information, instructions, questions, tasks, and/or examples related to one or more requirements corresponding to the software program that may cause the GLM 110 to provide information corresponding to fuzz testing the software program. As also discussed in further detail in the present disclosure, the test module 112 may be configured to interface and interact with the GLM 110 such that the fuzzing architecture 102 may be generated. For example, FIGS. 2-4 describe one or more operations that may be used to generate the fuzzing architecture 102.

The fuzzing architecture 102 may include a set of operations or instructions corresponding to fuzz testing the software program. For example, in some embodiments, the fuzzing architecture 102 may include a fuzzing test harness 120 (“test harness 120”) and/or seed inputs 122.

In general, the test harness 120 may include a software component (e.g., source code or code that may be referred to as “fuzzing code”) that is configured to be executed by a fuzzing system (“fuzzer”) configured to execute the fuzzing process. In the present disclosure, reference to operations being performed by the test harness 120 may also include operations that the test harness 120 may cause the fuzzer to perform.

The test harness 120 may be designed to facilitate automated testing of the software program by generating and feeding the software program with random or semi-random input data, which may test the software program's stability, security, and/or functionality. In many implementations, input generation and mutation are primarily handled by the fuzzer rather than the test harness 120. However, the test harness 120 may include mechanisms for customizing these processes within the harness, especially for specialized testing scenarios. The test harness 120 may include mechanisms for generating or mutating input data, passing this data to the software program, monitoring the software program's behavior and outputs, and/or logging or reporting any unexpected behaviors or crashes. While instrumentation for measuring code coverage is often integrated at the compiler or fuzzer level, including such instrumentation within the test harness 120 may be performed, particularly if the harness is designed to work closely with instrumentation tools. In these and other embodiments, the test harness 120 may also incorporate instrumentation for measuring code coverage and other metrics to assess the effectiveness of the fuzzing process.

For example, in some embodiments, the test harness 120 may include instrumentation framework that monitors the software program's behavior during execution, identifying anomalous states like crashes, memory leaks, or unexpected behavior. In these and other embodiments, the test harness 120 may record these events along with metadata, such as the input that triggered the fault and the specific code paths taken. Additionally or alternatively, to enhance coverage, the test harness 120 may also include feedback mechanisms, such as code coverage analysis, which guide the input generation process to explore untested paths more effectively. Including feedback mechanisms within the test harness 120 allows it to guide the fuzzer in exploring untested paths, even though code coverage analysis is often managed at the compiler or fuzzer level. By managing input generation, execution monitoring, and results analysis, the test harness 120 may enable automated and scalable vulnerability discovery across a wide array of the software program.

The seed inputs 122 may generally include an initial set of data used to start the fuzzing process (e.g., by being used by the test harness 120 as initial fuzzing inputs provided to the software program) In some embodiments, the seed inputs 122 may be crafted or selected to provide a starting point for exploring the target software's input space. For example, the seed inputs 122 may include valid, well-formed inputs that exercise different parts of the target software, or they may include edge cases and boundary conditions. The quality and diversity of the seed inputs 122 may significantly impact the effectiveness of the fuzzing process by helping the fuzzer discover new code paths and potential vulnerabilities more efficiently.

In some embodiments, the test module 112 may obtain program information 106 and may include one more prompt templates 108. In these and other embodiments, the test module 112 may be configured to generate prompts 114 based on the program information 106 and/or the prompt templates 108.

The program information 106 may include information that may indicate one or more aspects of the software program. For example, in some embodiments, the program information 106 may include the code 116 corresponding to the software program and/or an interface specification 118 corresponding to the software program. In these and other embodiments, as discussed in further detail in the present disclosure (e.g., with respect to FIG. 2) the program information 106 may be used to identify which portions of the software program (e.g., functions) where fuzzing may be particularly useful in identifying vulnerabilities, weaknesses, or other deficiencies in the software program.

In some embodiments, the prompt templates 108 may include pre-populated language. In some embodiments, the prompt templates 108 may include any suitable information that may indicate one or more requirements that may correspond to fuzzing the software program. For example, the prompt templates 108 may include pre-populated language related to specific context information, instructions, questions, tasks, and/or examples related to one or more requirements (e.g., requirement information). In some embodiments, requirement information may indicate certain vulnerabilities to target with the fuzzing. Additionally or alternatively, requirement information may indicate one or more target performance metrics of the software program with respect to how well the software program performs in light of the fuzzing.

Additionally or alternatively, requirement information may indicate certain requirements related to identification of elements of the software program (e.g., functions) that may be good targets for fuzzing. For example, in some embodiments, requirement information may indicate certain function characteristics that may correspond to functions that may be good targets for fuzzing. For example, requirement information may include one or more vulnerability metrics that may be used to identify functions that may be particularly vulnerable. In the present disclosure, reference to “functions” of a software program may include any component of the software program that is configured to execute, perform, and/or cause performance of a certain functionality. Examples of functions may include interfaces (e.g., application program interfaces (APIs)), methods, procedures, subroutines, event handlers, callbacks, etc. In some embodiments, requirement information may relate to the test harness 120 and/or the seed inputs 122.

In some embodiments, the prompt templates 108 may include instructions or information related to directing that the fuzzing target functions or components that have high risk metrics. Additionally or alternatively, the prompt templates 108 may direct compatibility requirements of the test harness 120 with respect to the fuzzer. In these and other embodiments, the prompt templates 108 may direct certain input formats for the test harness 120 to help ensure that the test harness 120 provides correct input formats to the functions of the code under test (“code”) 116. Additionally or alternatively, the prompt templates 108 may direct that the test harness 120 invoke dependencies of a function targeted for fuzzing before calling the target function. In these and other embodiments, the prompt templates 108 may indicate requirements related to the test harness 120 being required to verify return values of targeted functions in instances in which the targeted functions return values.

In addition, in some embodiments, the prompt templates 108 may include requirement information for the seed inputs 122 that may help maximize code coverage in the target functions (e.g., execute as many lines of code as possible with a given input). Additionally or alternatively, requirement information related to the seed inputs 122 may direct that inputs that test the boundaries of acceptable input ranges (e.g., empty inputs, extremely large inputs) be used. In these and other embodiments, requirement information related to the seed inputs 122 may direct that the seed inputs 122 provide both well-formed and intentionally malformed structured data (e.g., JSON, XML) to test parsing and validation logic. Additionally or alternatively, requirement information related to the seed inputs 122 may direct that if input data is compared with large constants (strings, byte arrays), then include those constants as part of the seed inputs 122.

Additionally or alternatively, the prompt templates 108 may include requirement information related to the fuzzing in general. For example, the fuzzing requirements may include a target amount of coverage of the fuzzing with respect to the software program, etc. In these and other embodiments, the fuzzing requirements may include execution time limitations (e.g., each fuzzing input should not cause the software to run for more than 8 seconds.); specific vulnerability types (e.g., use address and undefined behavior sanitizers with fuzzing to detect specific types of memory corruption issues); a number of fuzzing iterations—e.g., a target coverage of 85% line code coverage and minimum of 10 million fuzzing iterations for specific functions (e.g., a target function identified as high risk); and/or reproducible test cases (e.g., requirements to save inputs that cause crashes or unusual behavior for future analysis).

In some embodiments, the prompt templates 108 may include requirement information that indicates one or more requirements by including the specific information corresponding to such requirements. Additionally or alternatively, the prompt templates 108 may include one or more indicators (e.g., a code, a flag, a pointer, etc.) that may indicate from where corresponding requirement information may be obtained and/or that may be used to look up a corresponding requirement.

The test module 112 may be configured to receive the prompt templates 108 and identify and/or obtain one or more requirements based on requirement information that may be included in the prompt templates 108. As indicated, the test module 112 may identify and/or obtain the requirements based on one or more requirements being directly included in the prompt templates 108 and/or by looking up and/or acquiring one or more requirements based on corresponding indicators included in the prompt templates 108.

The prompt templates 108 may include a framework that the test module 112 may use to generate one or more of the prompts 114. For example, in some embodiments the prompt templates 108 may include pre-populated language that provides context, asks questions, describes tasks, describes commands, and/or describes examples that may be included in the prompts 114.

In some embodiments, the test module 112 may include a generative language model and may be configured to generate at least some of the pre-populated language included in the prompt templates 108. Additionally or alternatively, at least some of the pre-populated language may be manually entered.

In these and other embodiments, the prompt templates 108 may include one or more input fields that may be populated with specific information such that corresponding pre-populated language may be directed toward specific context, questions, tasks, commands, and/or examples that are based on the information included in the fields. For example, in some embodiments, one or more of the fields may be configured to be populated with at least some requirement information. As such, the pre-populated language that corresponds to such fields may be modified to correspond to a specific requirement associated with specific requirement information used to populate such fields. In the present disclosure, reference to populating a field with requirement information may include populating the field with any information about a particular requirement that may be obtained from the prompt templates 108.

In some embodiments, the prompt templates 108 may be blocks of code that may be executed by the test module 112. For example, the prompt templates 108 may include instructions that may be executed by the test module 112 that may receive certain inputs and then generate corresponding prompts 114 based on the inputs and instructions corresponding therewith.

The code 116 may include any portion of the software program that may be designated for fuzzing. In some embodiments, the code 116 may include source code, libraries, applications, scripts, or other logic or instructions corresponding to the software program for execution by a processing device. In some embodiments, the code 116 may include a complete instance of the software program. Additionally or alternatively, the code 116 may include a portion of the software program. The code 116 may be written in any suitable type of computer language that may be used for the software program.

In general, the interface specification 118 may provide guidelines on how to integrate and use the interfaces corresponding to the software program to help ensure consistency and compatibility across the software program. Overall, the interface specification 118 serves as a reference document that may describe or be used to identify communication between different parts of the software program and with external entities.

For example, in some embodiments, the interface specification 118 may include a description of how different components of the software program (e.g., functions) interact with each other and with external systems. For example, the interface specification 118 may define various functions (which may include interfaces), including APIs (Application Programming Interfaces), user interfaces, and communication protocols that may be used by the software program. Additionally or alternatively, the interface specification 118 may specify the methods, parameters, data formats, and/or return types corresponding to the or functions.

In these and other embodiments, the interface specification 118 may outline the expected behavior of one or more of the functions, such as error handling, performance requirements, and security constraints. Additionally or alternatively, the interface specification 118 may include examples and use cases to illustrate typical interactions between functions.

Additionally or alternatively, as described in further detail in the present disclosure (e.g., as discussed with respect to FIG. 2), one or more of the fields may be configured to be populated with program information 106. In the present disclosure, reference to populating a field with the “program information 106” may include populating the field with any information about the program information 106 and/or the software program itself that may be obtained from the program information 106.

In these and other embodiments and as discussed in further detail in the present disclosure (e.g., as discussed with respect to FIG. 2), one or more of the fields may be configured to be populated with additional information that may be obtained by the test module 112 during the process of generating the fuzzing architecture 102. For example, in some embodiments, the additional information may include information output by the GLM 110 in response to receiving one or more of the prompts 114, as discussed in further detail herein.

The system 100 may accordingly be configured to generate the fuzzing architecture 102 based on interactions with the GLM 110. Such a configuration may help improve the efficiency of generation of the fuzzing architecture 102 and/or improve the quality of the fuzzing architecture 102 itself as compared to other techniques.

Modifications, additions, or omissions may be made to the system 100 without departing from the scope of the present disclosure. In these and other embodiments, the prompt templates 108 may be omitted and/or very simplified in which the GLM of the test module 112 may have a simple instruction to analyze the program information 106 and generate the fuzzing architecture 102 accordingly. In these and other embodiments, in some embodiments, the system 100 may be configured to perform one or more operations as discussed with respect to FIG. 2 in the generation of the fuzzing architecture 102.

FIG. 2 illustrates an example process 200 that may be performed to generate fuzz testing architecture 250 (“fuzzing architecture 250”) for code-under-test 216, according to one or more embodiments of the present disclosure. Each operation or block of the process 200 described herein, may comprise a computing process that may be performed using any combination of hardware, firmware, and/or software. For instance, various functions may be carried out by a processor executing instructions stored in memory. The process 200 may also be embodied as computer-usable instructions stored on computer storage media. The process 200 may be provided by a standalone application, a service or hosted service (standalone or in combination with another hosted service), as a microservice via an application programming interface (API) or a plug-in to another product, to name a few. In addition, the process 200 is described, by way of example, with respect to the system of FIG. 1. However, the process 200 may additionally or alternatively be executed by any one system, or any combination of systems, including, but not limited to, those described herein.

The code under test 216 (“code 216”) may be analogous to the code under test 116 of FIG. 1. For example, the code-under-test may include a software program or part of a software program that may be targeted for fuzz testing.

The process 200 may include a function identification operation 208 (“function identification 208”). The function identification 208 may include identifying, as target functions 210, one or more functions of the code 216 that may be targets for fuzzing. In some embodiments, the function identification 208 may include identifying the target functions 210.

In some embodiments, the function analysis prompt template 224 may be configured to evaluate the code 216 inputted as part of program information 206. For example, evaluating the code 216 may include the function analysis prompt template 224 generating a score for one or more of the vulnerability metrics. In some embodiments, the function analysis prompt template 224 may calculate a score (e.g., between 0 and 10) for a vulnerability metric corresponding to dangerous expressions. For example, a score of 0 may indicate no dangerous expressions were detected in the code 216 and the closer the score is to 10 may indicate an increasing number of dangerous expressions detected. In some embodiments, the function analysis prompt template 224 may be configured to rank the functions based on the score(s). In some embodiments, functions ranked above a threshold (e.g., functions receiving a score greater than or equal to 8, functions receiving a score within the 90th percentile for a particular vulnerability metric, etc.) may be identified as target functions 210. In some embodiments, the function analysis prompt template 224 may be configured to send the identified target functions 210 on for test harness generation 244.

For example, in some embodiments, the vulnerability metrics may include any characteristics of particular functions that may expose the software program to security and/or performance risks. For example, the vulnerability characteristics may include exposure to other internal and/or external functions (e.g., number of components that may call the functions), usage of certain expressions that may lead to exposure (e.g., use of pointers and/or pointer dereferences), usage of certain memory access operations (e.g., memcpy/strcpy, or other similar memory operations), cyclomatic complexity of the code 216 corresponding to the functions, etc.

The function identification 208 may include identifying as the target functions 210 functions that may correspond to and/or include the vulnerability metrics. In these and other embodiments, the function identification 208 may include identifying functions that satisfy a particular threshold of vulnerability metrics. Additionally or alternatively, different vulnerability metrics may be weighted differently in such an assessment. In these and other embodiments, the weighting may be based on a heuristic analysis as to which vulnerability metrics may correspond to different degrees of potential negative exposure. In these and other embodiments, the function identification 208 may include a function analysis prompt template 224 that may include information corresponding to targeted functionality for the fuzzing and the vulnerability metrics that may correspond to such functionality.

In some embodiments, the function identification 208 may include generating one or more function identification prompts that may be provided to a GLM—e.g., the testing module 112 of FIG. 1 may generate one or more function identification prompts that may be provided to the GLM 110 of FIG. 1. In these and other embodiments, the function identification prompts may be generated based on the program information 206 and the function analysis prompt template 224.

The function analysis prompt template 224 may be included in the prompt templates 108 of FIG. 1 in some embodiments. In these and other embodiments, the function analysis prompt template 224 may be specifically directed toward generating prompts that may be used to identify the target functions 210.

For example, the function analysis prompt template 224 may include pre-populated language that is directed toward instructing the GLM to search for portions of the code 216 that may correspond to one or more vulnerability metrics. In these and other embodiments, the function analysis prompt template 224 may include input fields associated with the pre-populated language that may be configured to be populated with at least some requirement information (e.g., the vulnerability metrics).

In these and other embodiments, the function analysis prompt template 224 may include fields associated with the program information 206 that may be configured to be populated with at least some of the program information 206. For example, the function analysis prompt template 224 may be populated with the code 216 and/or a reference to the code 216 such that the GLM may access and analyze the code 216. In these and other embodiments, the function analysis prompt template may be populated with the interface specification 218 which may provide information about the different functions and may help the GLM identify which functions may correspond to which vulnerability metrics.

In these and other embodiments, the pre-populated language may include additional instructions related to the task at hand, such as one or more directed instructions that describe the task at hand in more detail. Additionally or alternatively, the pre-populated language may describe how the GLM may go about identifying the target functions 210. For example, the pre-populated language may include one more lists of “do's” and/or “don't's” related to identifying the target functions 210. In these and other embodiments, the pre-populated language may instruct the GLM regarding the format of the output that may be obtained. Additionally or alternatively, the pre-populated language may include examples corresponding to the output such as example outputs themselves, examples of what the output may look like, examples of how the output may be formatted, etc.

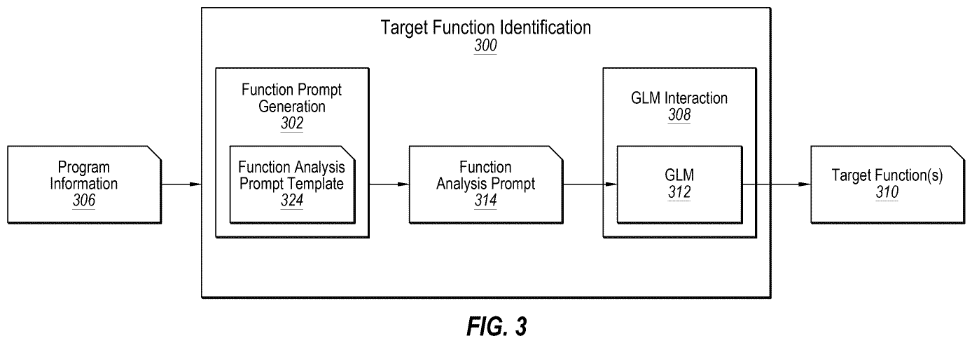

The pre-populated language of the function analysis prompt template 224 combined with the populated fields corresponding to the program information 206 may accordingly result in a prompt that directs the GLM to identify from the code 216 the target functions 210. As discussed in further detail with respect to FIG. 3, in some embodiments, the function identification 208 may accordingly include applying the program information 206 to the function analysis prompt template 224 and executing the function analysis prompt template 224 to generate the corresponding function identification prompt. The function identification 208 may then include providing the function identification prompt to the GLM and the GLM may identify the target functions 210 based on the function identification prompt.

In some embodiments, the process 200 may include a fuzz testing architecture generation operation 236 (“fuzzing architecture generation 236”). In general, the fuzzing architecture generation 236 may be configured to generate one or more elements of the fuzzing architecture 250, such as those described with respect the fuzzing architecture 102 of FIG. 1. Additionally or alternatively, in some embodiments, the fuzzing architecture generation 236 may be configured to generate one or more portions of the fuzzing architecture 250 based on one or more of the target functions 210, as discussed in further detail herein.

In these and other embodiments, the fuzzing architecture generation 236 may include a test harness generation operation 244 (“test harness generation 244”) configured to generate a test harness 220. The test harness 220 may be similar or analogous to the test harness 120 described with respect to FIG. 1. In some embodiments, the test harness generation 244 may be configured to generate the test harness 220 based on the target functions 210 and a test harness prompt template 240.

The test harness prompt template 240 may be included in the prompt templates 108 of FIG. 1 in some embodiments. In these and other embodiments, the test harness prompt template 240 may be specifically directed toward generating prompts that may be used to generate test harnesses.

In some embodiments, the test harness prompt template 240 may be configured to identify pre-conditions and/or post-conditions for the target functions 210. In some embodiments, pre-conditions may be function calls made before the function being analyzed can be called. For example, a pre-condition may be a function call to open a file (e.g., before the file can be read). In some embodiments, post conditions may be function calls that clean up memory, free up resources, etc. For example, a post-condition may be a function call to close the file after the file is read.

In some embodiments, the test harness prompt template 240 may generate (e.g., compile) the test harness 220. In some embodiments, the test harness generation 244 may include outputting a test harness 220 for each of the target functions 210 identified by the function identification 208.

For example, the test harness prompt template 240 may be configured to receive the target functions 210 as inputs. In these and other embodiments, the test harness prompt template 240 may include pre-populated language that is directed toward instructing the GLM to generate the test harness 220 based on the provided input.

For instance, the pre-populated language may include general instructions directing the GLM to generate the test harness 220 based on one or more fuzzing requirements. In these and other embodiments, the pre-populated language may include instructions related to the format of the test harness 220.

Additionally or alternatively, in some embodiments, the pre-populated language may include more specific instructions directing the GLM how to go about generating the test harness 220. For example, the pre-populated language may instruct the GLM to parse the target functions 210 to identify characteristics of the target functions that may be used as part of or in association with the generation of the test harness 220. For instance, the characteristics may include dependencies between functions, types of input arguments for the functions, cleanup routines, and/or return values for the functions. In some embodiments, requirement information including information related to the characteristics of the target functions 210 for the GLM may be used as part of the test harness 220.

Additionally or alternatively, the pre-populated language may include instructions on how the GLM may begin generating the test harness 220 and/or one more lists of “do's” and/or “don't's” related to the generation of the test harness 220. In these and other embodiments, the pre-populated language may include certain requirements that the test harness 220 should meet and/or specific characteristics of the test harness 220. Additionally or alternatively, the pre-populated language may include example test harnesses that the GLM may use in the generation of the test harness 220.

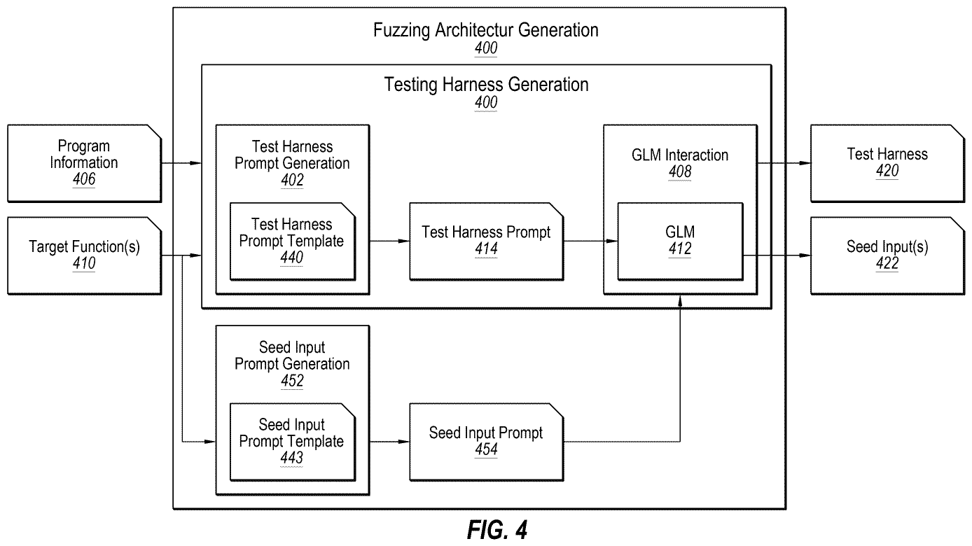

As discussed in further detail with respect to FIG. 4, in some embodiments, the test harness generation 244 may accordingly include providing the applicable target functions 210 to the test harness prompt template 240 and executing the test harness prompt template 240 to generate a corresponding test harness prompt. The test harness generation 244 may then include providing the test harness prompt to the GLM and the GLM may generate the test harness 220 based on the test harness prompt.

In some embodiments, the test harness generation 244 may include verifying the test harness 220 with respect to potential errors, such as syntax errors or logical errors. For instance, the verification may include identifying missing headers, incorrect data types, or attempt to build or run generated test harness with compiler or code interpreter. In some embodiments, the verification may include providing the test harness 220 to a compiler to determine whether the test harness 220 properly compiles.

In these and other embodiments, the verification may include modifying the test harness 220 based on errors that may be identified. For example, the identified errors may be provided to the GLM with instructions for the GLM to correct the identified errors in the test harness 220. As such, in some embodiments, multiple iterations of the test harness 220 (e.g., multiple versions of fuzzing code) may be generated (e.g., based on multiple test harness prompts) prior to settling on a finalized version of the test harness 220.

In some embodiments, the fuzzing architecture generation 236 may also include a seed input generation operation 246 (“seed input generation 246”) configured to generate one or more seed inputs 222 for the test harness 220. In some embodiments, the seed input generation 246 may be configured to output one or more seed inputs 222 corresponding to each of the target functions 210. In some embodiments, the seed inputs 222 may be similar or analogous to the seed inputs 122 described with respect to FIG. 1. Additionally or alternatively, the seed inputs 222 may be data used by the test harness 220 as input arguments to test the target functions 210. In some embodiments, the seed inputs 222 may be based on the data type of the function arguments and function logic of each of the target functions 210.

In some embodiments, the seed input generation 246 may be configured to generate the seed inputs 222 using any suitable technique. For example, in some embodiments the seed inputs 222 may be generated using target code analysis techniques, analyzing target control and data flows, extracting constants and condition branch values from the code 216, etc.

In these and other embodiments, the seed input generation 246 may include generating the seed inputs 222 based on the target functions 210 and a seed input prompt template 243. The seed input prompt template 243 may be included in the prompt templates 108 of FIG. 1 in some embodiments. In these and other embodiments, the seed input prompt template 243 may be specifically directed toward generating prompts that may be used to generate seed inputs.

For example, the seed input prompt template 243 may be configured to receive the target functions 210 as inputs. In these and other embodiments, identifiers of the target functions 210 may be populated into one or more input fields included in the seed input prompt template 243. Additionally or alternatively, the seed input prompt template 243 may include pre-populated language that is directed toward instructing the GLM to generate the seed inputs 222 based on the populated input. In these and other embodiments, the pre-populated language may include more specific instructions directing the GLM how to go about generating the seed inputs 222.

For instance, the pre-populated language may include general instructions directing the GLM to generate the seed inputs 222 based on implementations of the target functions 210 that may be identified in the target functions 210 as part of the test harness generation 244 and that may be fuzzed. In these and other embodiments, the pre-populated language may include instructions related to a type of analysis to perform with respect to the target functions 210 to identify the seed inputs.

For example, the pre-populated language may include instructions related to analyzing arguments of the target functions. For instance, the pre-populated language may include instructions for analyzing the data flow within a particular function implementation. In these and other embodiments, the data flow analysis instructions may direct that data types for the arguments be identified (e.g., integer, float, string, struct, etc.). Additionally or alternatively, the data flow analysis instructions may direct that usage patterns for how the argument is utilized within the function be analyzed. For instance, to identify whether there are conditions, loops, specific operations, etc., that involve the arguments. Additionally or alternatively, the data flow analysis instructions may direct for the detection of constants and/or magic numbers that may be used in relation to the arguments.

In these and other embodiments, the pre-populated language may include seed-input instructions related to use of the information obtained during the argument analysis may be used to generate the seed inputs 222. For example, the seed-input instructions may direct the generation of one or more binary blobs that operate as respective seed inputs to the target functions 210. In these and other embodiments, the seed-input instructions may direct that the binary blobs be generated based on the identified data types, data flow (e.g., usage patterns), and/or extracted constants and/or magic numbers. Additionally or alternatively, the seed-input instructions may provide certain objectives for the seed input generation, such as, for example to maximize data coverage when the function is executed.

In these and other embodiments, the seed-input generation instructions may include one or more guidelines for the generation of the seed inputs. For example, the guidelines may include instructions for the GLM to ensure that the binary blob correctly represents the data types of the function arguments, that the magic numbers are included in the binary blob, that the binary blob is designed to explore a wide range of possible execution paths to help increase or maximize code coverage, etc.

Additionally or alternatively, the pre-populated language may include instructions on how the GLM may begin generating the seed inputs 222 and/or one more lists of “do's” and/or “don't's” related to the generation of the seed inputs 222. In these and other embodiments, the pre-populated language may include certain requirements that the seed inputs 222 should meet and/or specific characteristics of the seed inputs 222. Additionally or alternatively, the pre-populated language may include an example workflow that the GLM may use in the generation of the seed inputs 222.

In these and other embodiments, the pre-populated language may include instructions related to the format of the seed inputs 222. Additionally or alternatively, the format instructions may include one or more example seed inputs.

As discussed in further detail with respect to FIG. 4, in some embodiments, the seed input generation 246 may accordingly include providing the applicable target functions 210 to the seed input prompt template 243 and executing the seed input prompt template 243 to generate a corresponding seed input prompt. The seed input generation 246 may then include providing the seed input prompt to the GLM and the GLM may generate the seed inputs 222 based on the seed input prompt.

In some embodiments, the process 200 may include a software program fuzzing operation 252 (“fuzzing 252”). In general, the fuzzing 252 may be configured to fuzz test the software program corresponding to the code 216 based on the fuzzing architecture 250. For example, the fuzzing 252 may include the test module 112 of FIG. 1 executing the code of the test harness 222 with respect to the software program to run the fuzzing in which the test harness 220 is initialized with the seed inputs 222.

In these and other embodiments, the fuzzing 252 may include evaluating a performance of the fuzzing of the software program. The evaluation may be based on one or more fuzzing criteria for the fuzzing in some embodiments.

For example, in some embodiments the fuzzing criteria may include a degree of coverage of the software program. In some embodiments, the evaluating may include determining the degree of coverage of the software program during the fuzzing. For instance, one or more applicable coverage techniques may be used to collect information indicating which functionality of the software program was covered by the fuzzing. Additionally or alternatively, it may be determined which lines of code, which percentage of the lines of code, which particular functions, etc., may have been covered during the fuzzing.

In these and other embodiments, it may be determined whether the fuzzing covered a threshold amount of the software program. For example, it may be determined whether a threshold percentage of the code 216 was executed and/or whether a threshold percentage of functionality was tested. The threshold amounts may vary depending on certain testing tolerances, specifications, requirements, etc. In some embodiments, the threshold amounts may be based on a heuristic analysis related to the amount of coverage and the satisfaction of such tolerances, specifications, requirements, etc.

In these and other embodiments, it may be determined whether the target functions 210 were adequately covered during the fuzzing. For example, it may be determined whether the functionalities, lines of code associated, etc. associated with the target functions 210 were covered by a threshold amount.

In some embodiments, in response to determining that the threshold amount of coverage was not met, the fuzzing 252 may be configured to update one or more of the prompts that are generated during the process 200. For example, the fuzzing 252 may include modifying the prompts to be directed toward gaps in fuzzing coverage that may be identified from the identified coverage results. In these and other embodiments, the updating of the prompts may result in modifications to the test harness 220 and/or the seed inputs 222 such that the fuzzing 222 may be improved based on the performance of the software program testing 252.

Additionally or alternatively, the fuzzing 252 may include generating one or more fuzzing results 254 based on the fuzzing. The fuzzing results 254 may include information about errors (e.g., crashes) of the software program that may occur as a result of the fuzzing 252. In these and other embodiments, the information may include portions of the code 216 (e.g., one or more target functions 210) that may be involved with the errors (e.g., affected by and/or that caused the errors), input dependencies, a detailed log from memory sanitizers, a call graph, etc. that may be related to the errors.

In some embodiments, the process 200 may include a software program repair operation 256 (“repair 256”). In general, the repair 256 may include one or more operations that may be used to modify the code 216 based on the fuzzing results 254. For example, the repair 256 may include generating one or more patches that modify a target portion of the code 216 based on the errors to reduce or eliminate the chances of such an error occurring again.

In some embodiments, the patch generation may include the use of one or more GLMs. For example, the one or more GLMs may be used to analyze potential crashes and/or defects that were detected during the fuzzing 252. In some embodiments, the repair 256 may be configured to generate a patch prompt for a GLM based on the fuzzing results 254 and a patch prompt template 258.

The patch prompt template 258 may be included in the prompt templates 108 of FIG. 1 in some embodiments. In these and other embodiments, the patch prompt template 258 may be specifically directed toward generating prompts that may be used to generate one or more patches 260 of software programs.

For instance, the patch prompt template 258 may be configured to receive as inputs, the fuzzing results 254 and at least a portion of the program information 206. In these and other embodiments, the patch prompt template 258 may include pre-populated language that is directed toward instructing the GLM to generate one or more patches 260 based on the provided input.

For instance, the pre-populated language may include general instructions directing the GLM to generate the patches 260 based on the type of errors and/or portions of the code affected by the errors as indicated in the fuzzing results 254. In these and other embodiments, the pre-populated language may include instructions related to the format of the patches 260.

Additionally or alternatively, in some embodiments, the pre-populated language may include more specific instructions directing the GLM how to go about generating the patches 260. For example, the pre-populated language may instruct the GLM to generate, as the patches 260, code that corrects the errors and to use the program information 206 to understand which portions of the code 216 may be patched and syntax, inputs, etc. that may be used in the generation of the patches.

Additionally or alternatively, the pre-populated language may include instructions on how the GLM may begin generating the patches 260 and/or one more lists of “do's” and/or “don't's” related to the generation of the patches 260. In these and other embodiments, the pre-populated language may include certain requirements that the patches 260 should meet and/or specific characteristics of the patches 260. Additionally or alternatively, the pre-populated language may include example patches that the GLM may use in the generation of the patches 260.

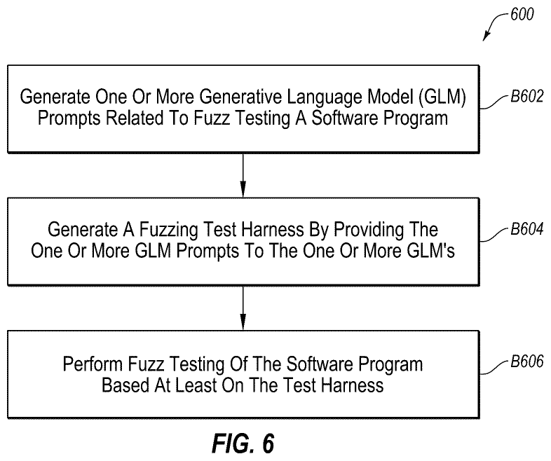

As discussed in further detail with respect to FIG. 6, in some embodiments, the repair 256 may accordingly include providing the applicable program information 206 and fuzzing results 254 to the patch prompt template 258 and executing the patch prompt template 258 to generate a corresponding patch prompt. The repair 256 may then include providing the patch prompt to the GLM and the GLM may generate one or more patches 260 based on the patch prompt.

In some embodiments, the patches 260 may be applied to the code 216. In these and other embodiments, after one or more patches 260 have been applied to the code 216, the corresponding test harness 220 may be used again to determine whether one or more detected issues still persist or were resolved. In some embodiments where the issue(s) are resolved, the one or more patches 260 may be outputted. Alternatively or additionally, additional crash/defect data may be used by the patch prompt template 258 to generate one or more additional patches 260.

The process 200 may accordingly be configured to leverage one or more GLMs as part of fuzzing software programs. The use of the GLMs to generate the test harness 220 and/or the seed inputs 222 as part of the process 200 may improve the efficiency of software fuzzing in general, which may improve the technological field of software development.

Modifications, additions, or omissions may be made to the process 200 without departing from the scope of the present disclosure. For example, although illustrated as discrete blocks or operations, various blocks or operations of the process 200 may be divided into additional blocks, combined into fewer blocks, or eliminated, depending on the particular implementations. Further, in some embodiments, one or more of the operations may be combined into fewer operations or expanded out to include additional operations.

For example, the number of prompts that are generated may vary depending on implementations. For instance, in some embodiments, two or more prompts may be combined into a single prompt. Additionally or alternatively, one or more prompts may be divided into additional prompts.

In addition, the different operations may be performed by various elements different from those described. For example, in some embodiments, one or more operations described as being performed by a test module (e.g., the test module 112 of FIG. 1) may be performed by a GLM, which may or may not be included as part of the test module 112. Further, in some embodiments a same GLM may be used to perform all of the operations described with respect to the GLM. Additionally or alternatively, two or more GLMs may be used.

FIG. 3 illustrates an example target function identification process 300 (“process 300”), according to one or more embodiments of the present disclosure. Each operation or block of the process 300 described herein, may comprise a computing process that may be performed using any combination of hardware, firmware, and/or software. For instance, various functions may be carried out by a processor executing instructions stored in memory. The process 300 may also be embodied as computer-usable instructions stored on computer storage media. The process 300 may be provided by a standalone application, a service or hosted service (standalone or in combination with another hosted service), as a microservice via an application programming interface (API) or a plug-in to another product, to name a few. The process 300 may be performed, by way of example, by one or more elements of the system of FIG. 1, the computing device of FIG. 8, and/or the data center of FIG. 9. However, the process 300 may additionally or alternatively be executed by any one system, or any combination of systems, including, but not limited to, those described herein. Further, to ease explanation, the description of the process 300 is given with respect to identifying target functions of a software program. The software program may include any suitable software program, such as any of those described in the present disclosure.

In addition, in some embodiments, one or more of the operations of the process 300 may be used to perform one or more operations of the function identification 208 described with respect to FIG. 2. However, the process 300 is not limited only to implementations of the function identification 208.

The process 300 may include a function prompt generation operation 302 (“function prompt generation 302”) that may be used to generate a function analysis prompt 314. The function analysis prompt 314 may be generated based on program information 306 and a function analysis prompt template 324. The program information 306 may be similar or analogous to the program information 206 of FIG. 2, and the function analysis prompt template 324 may be similar or analogous to the function analysis prompt template 224 of FIG. 2.

In some embodiments, the function prompt generation 302 may include providing—e.g., by the test module 112 of FIG. 1—the program information 306 as inputs to the function analysis prompt template 324. In the present disclosure, reference to providing the “program information 306” as an input may refer to references to the program information 306 that may be used to identify where to find and/or access the program architecture 316.

In these and other embodiments, the function prompt generation 302 may include causing the function analysis prompt template 324 to be executed to generate the function prompt 314 based on the pre-populated language of the function analysis prompt template 324, which may include requirement information, and program information 306.

In these and other embodiments, the process 300 may include a GLM interaction operation 308 (“GLM interaction 308”). The GLM interaction 308 may include providing the function prompt 314 to a GLM 312, which may be similar or analogous to the GLM 110 of FIG. 1. In these and other embodiments, the GLM 312 may identify, as target functions 310, one or functions of the software program that may be targeted for fuzzing. In some embodiments, the GLM 312 may output the target functions 310. The target functions 310 may be similar or analogous to the target functions 210 of FIG. 2.

Modifications, additions, or omissions may be made to the process 300 without departing from the scope of the present disclosure. For example, although illustrated as discrete blocks or operations, various blocks or operations of the process 300 may be divided into additional blocks, combined into fewer blocks, or eliminated, depending on the particular implementations. Further, in some embodiments, one or more of the operations may be combined into fewer operations or expanded out to include additional operations. For example, multiple iterations of the process 300 may be performed to determine target functions 310 based on various metrics (e.g., vulnerability metrics including cyclomatic complexity, buffer overflow potential, third-party dependency, etc.).

In some embodiments, determining target functions 310 based on various metrics may include performing multiple iterations of the process 300 with a different function analysis prompt template 324 corresponding to a different metric each iteration. For example, a first iteration may use a first function analysis prompt template 324 configured to identify functions susceptible to buffer overflow vulnerabilities and a subsequent iteration may employ a second function analysis prompt template 324 configured to detect functions susceptible to memory corruption errors. Additionally or alternatively, performing multiple iterations of the process 300 may include using a single function analysis prompt template 324 configured to use a different metric each iteration.

In some embodiments, using one or more function analysis prompt templates 324 based on different metrics may include identifying a more diverse set of target functions 310. For example, a function analysis prompt template 324 configured to assess code complexity may result in a function analysis prompt 314 that differs significantly from a function analysis prompt 314 generated based on a function analysis prompt template 324 configured to identify potential software race conditions. To continue the example, different function analysis prompts 314 may interact with the GLM 312 differently such that different target functions 310 are identified each iteration. In these and other embodiments, performing multiple iterations of the process 300 using one or more function analysis prompt templates 324 based on multiple metrics may improve the identification of a broad range of security issues included in target functions 310 as part of software fuzz testing.

FIG. 4 illustrates an example fuzzing architecture generation process 400 (“process 400”), according to one or more embodiments of the present disclosure. Each operation or block of the process 400 described herein, may comprise a computing process that may be performed using any combination of hardware, firmware, and/or software. For instance, various functions may be carried out by a processor executing instructions stored in memory. The process 400 may also be embodied as computer-usable instructions stored on computer storage media. The process 400 may be provided by a standalone application, a service or hosted service (standalone or in combination with another hosted service), as a microservice via an application programming interface (API) or a plug-in to another product, to name a few. The process 400 may be performed, by way of example, by one or more elements of the system of FIG. 1, the computing device of FIG. 8, and/or the data center of FIG. 9. However, the process 400 may additionally or alternatively be executed by any one system, or any combination of systems, including, but not limited to, those described herein. In addition, in some embodiments, one or more of the operations of the process 400 may be used to perform one or more operations of the test harness generation 244 and/or seed input generation 246 described with respect to FIG. 2. However, the process 400 is not limited only to implementations of the test harness generation 244 and/or the seed input generation 246.

In some embodiments, the process 400 may include test harness prompt generation operation 402 (“test harness prompt generation 402”) that may be used to generate a test harness prompt 414. The test harness prompt 414 may be generated based on program information 406, one or more target functions 410, and a test harness prompt template 440. The program information 406 may be similar or analogous to the program information 206 of FIG. 2, the target functions 410 may be similar or analogous to the target functions 210 of FIG. 2, and the test harness prompt template 440 may be similar or analogous to the test harness prompt template 240 of FIG. 2.

In some embodiments, the test harness prompt generation 402 may include providing—e.g., by the test module 112 of FIG. 1—the program information 406 and the target functions 410 as inputs to the test harness prompt template 440—e.g., such as described with respect to FIG. 2.

In some embodiments, the test harness prompt generation 402 may include causing the test harness prompt template 440 to be executed using the inputted program information 406 and target functions 410. The execution of the test harness prompt template 440 accordingly may generate the test harness prompt 414 based on the pre-populated language of the test harness prompt template 440 and the inputted program information 406 and target functions 410.

In some embodiments, the process 400 may include seed input prompt generation operation 452 (“seed input prompt generation 452”) that may be used to generate a seed input prompt 454. The seed input prompt 454 may be generated based on one or more of the target functions 410 and a seed input prompt template 443. The seed input prompt template 443 may be similar or analogous to the seed input prompt template 243 of FIG. 2.

In some embodiments, the seed input prompt generation 452 may include providing—e.g., by the test module 112 of FIG. 1—the target functions 410 as inputs to the seed input prompt template 443—e.g., such as described with respect to FIG. 2.

In some embodiments, the seed input prompt generation 452 may include causing the seed input prompt template 443 to be executed using the inputted target functions 410. The execution of the seed input prompt template 443 accordingly may generate the seed input prompt 454 based on the pre-populated language of the seed input prompt template 443 and the target functions 410.

In these and other embodiments, the process 400 may include a GLM interaction operation 408 (“GLM interaction 408”). The GLM interaction 408 may include providing the test harness prompt 406 to a GLM 412, which may be similar or analogous to the GLM 110 of FIG. 1. In these and other embodiments, the GLM 412 may generate a test harness 420 based on the test harness prompt 414. In some embodiments, the GLM 412 may output the test harness 420. The test harness 420 may be similar or analogous to the test harness 220 of FIG. 2 in some embodiments.

Additionally or alternatively, the GLM interaction 408 may include providing the seed input prompt 454 to the GLM 412. In these and other embodiments, the GLM 412 may generate one or more seed inputs 422 based on the seed input prompt 454. In some embodiments, the GLM 412 may output the seed inputs 422. The seed inputs 422 may be similar or analogous to the seed inputs 222 of FIG. 2 in some embodiments

Modifications, additions, or omissions may be made to the process 400 without departing from the scope of the present disclosure. For example, although illustrated as discrete blocks or operations, various blocks or operations of the process 400 may be divided into additional blocks, combined into fewer blocks, or eliminated, depending on the particular implementations. Further, in some embodiments, one or more of the operations may be combined into fewer operations or expanded out to include additional operations.

In addition, in some embodiments, the GLM 412 may be the same as the GLM 312 of FIG. 3. Additionally or alternatively, the GLM 412 may be different from the GLM 312 of FIG. 3.

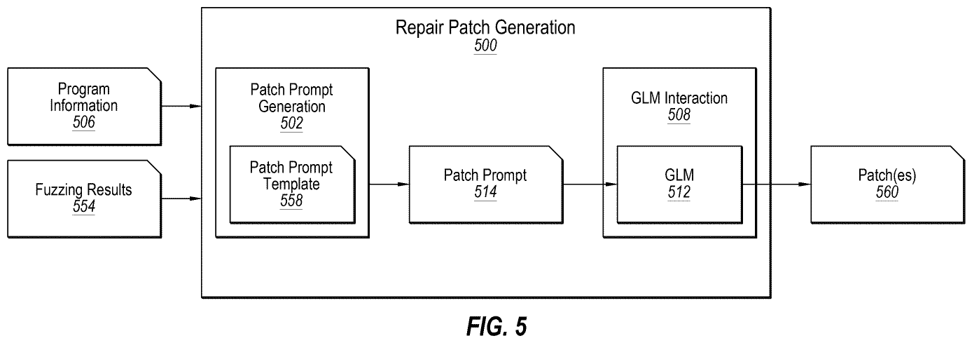

FIG. 5 illustrates an example repair patch generation process 500 (“process 500”), according to one or more embodiments of the present disclosure. Each operation or block of the process 500 described herein, may comprise a computing process that may be performed using any combination of hardware, firmware, and/or software. For instance, various functions may be carried out by a processor executing instructions stored in memory. The process 500 may also be embodied as computer-usable instructions stored on computer storage media. The process 500 may be provided by a standalone application, a service or hosted service (standalone or in combination with another hosted service), as a microservice via an application programming interface (API) or a plug-in to another product, to name a few. The process 500 may be performed, by way of example, by one or more elements of the system of FIG. 1, the computing device of FIG. 8, and/or the data center of FIG. 9. However, the process 500 may additionally or alternatively be executed by any one system, or any combination of systems, including, but not limited to, those described herein. In addition, in some embodiments, one or more of the operations of the process 500 may be used to perform one or more operations of the software program repair 256 described with respect to FIG. 2. However, the process 500 is not limited only to implementations of the software program repair 256.

The process 500 may include a patch prompt generation operation 502 (“patch prompt generation 502”) that may be used to generate a patch prompt 514. The patch prompt 514 may be generated based on program information 506, one or more fuzzing results 554, and a patch prompt template 558. The program information 506 may be similar or analogous to the program information 206 of FIG. 2, the fuzzing results 554 may be similar or analogous to the fuzzing results 254 of FIG. 2, and the patch prompt template 558 may be similar or analogous to the patch prompt template 258 of FIG. 2.

In some embodiments, the patch prompt generation 502 may include providing—e.g., by the test module 112 of FIG. 1—the program information 506 and the fuzzing results 554 as inputs to the patch prompt template 558. In these and other embodiments, the patch prompt generation 502 may include causing the patch prompt template 558 to be executed using the inputted program information 506 and fuzzing results 554. The execution of the patch prompt template 558 accordingly may generate the patch prompt 514 based on the pre-populated language of the patch prompt template 558 and the inputted program information 506 and fuzzing results 554.

In these and other embodiments, the process 500 may include a GLM interaction operation 508 (“GLM interaction 508”). The GLM interaction 508 may include providing the patch prompt 514 to a GLM 512, which may be similar or analogous to the GLM 110 of FIG. 1. In these and other embodiments, the GLM 512 may generate one or more software repair patches 560 based on the patch prompt 514. In some embodiments, the GLM 512 may output the patches 560. Additionally or alternatively, the GLM and/or another component may implement one or more of the patches 560 in the corresponding software program.

Modifications, additions, or omissions may be made to the process 500 without departing from the scope of the present disclosure. For example, although illustrated as discrete blocks or operations, various blocks or operations of the process 500 may be divided into additional blocks, combined into fewer blocks, or eliminated, depending on the particular implementations. Further, in some embodiments, one or more of the operations may be combined into fewer operations or expanded out to include additional operations.

Further, in some embodiments, the GLM 512 may be the same as the GLM 312 of FIG. 3 and/or the GLM 412 of FIG. 4. Additionally or alternatively, the GLM 512 may be different from the GLM 312 of FIG. 3, and/or the GLM 412 of FIG. 4.

Now referring to FIG. 6, each block of method 600, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. The method 600 may be performed, by way of example, by one or more elements of the system of FIG. 1, the computing device of FIG. 8, and/or the data center of FIG. 9. However, this method may additionally or alternatively be executed by any one system, or any combination of systems, including, but not limited to, those described herein.

FIG. 6 is a flow diagram showing the method 600 for generating fuzzing architecture for a software program, according to one or more embodiments of the present disclosure. The method 600, at block B602, includes generating one or more GLM prompts related to fuzz testing a software program. The one or more GLM prompts may be based at least on one or more prompt templates that are populated based at least on program information that describes the software program and requirement information that describes a requirement of the software program.

Additionally or alternatively, the one or more GLM prompts may be configured to cause one or more GLM's to identify one or more functions of the software program to fuzz test. In these and other embodiments, one or more of the GLM prompts may be configured to cause the GLM to generate a fuzzing test harness (“test harness”) that includes fuzzing source code configured to execute the fuzz testing of the functions of the software program as identified. Additionally or alternatively, one or more of the prompts may be used to generate one or more repair patches of the software program based on the results of the fuzz testing. In some embodiments, one or more of the prompts may be generated based on one or more operations described with respect to FIGS. 1-5 of the present disclosure.

At block B604, the test harness may be generated by providing the one or more GLM prompts to the one or more GLM's. For example, the test harness may be generated based on one or more outputs of the GLM that correspond to the GLM prompts. In some embodiments, the test harness may be generated based on one or more operations described with respect to FIGS. 1-5 of the present disclosure.

At block B606, fuzz testing of the software program may be performed based on the test harness in some embodiments. In some embodiments, the fuzz testing may be based on one or more operations described with respect to FIGS. 1 and 2 of the present disclosure.

Modifications, additions, or omissions may be made to the method 600 without departing from the scope of the present disclosure. For example, although illustrated as discrete blocks, various blocks of the method 600 may be divided into additional blocks, combined into fewer blocks, or eliminated, depending on the particular implementations. Further, in some embodiments the method 600 may include additional operations than those explicitly stated with respect to the method 600. For example, the method 600 may include any of the operations described in the present disclosure with respect to FIGS. 1-5.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation.

LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models- or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc.of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model —or version, instance, or agent-maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which may include an LLM, a VLM, a MMLM, a VLA model, etc.).

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 730 (e.g., LLM/VLM/MMLM/etc.). In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multi-modal inputs, the input 701 may combine text (or may omit text) with image data, audio data, video data, design data, USD data, and/or other types of input data, such as but not limited to those described herein. Taking raw input text as an example, the input processor 705 may prepare raw input text in various ways. For example, the input processor 705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 705 may remove stopwords to reduce noise and focus the generative LM 730 on more meaningful content. The input processor 705 may apply text normalization (TN), for example, by converting all characters to lowercase, removing accents, and/or or handling special cases like contractions or abbreviations to ensure consistency (e.g., converting ¼ to one quarter). Similarly, the input processor 705 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 792 (which may include one or more RAG models, and/or may be performed using the generative LM 730 itself) may be used to retrieve additional information to be used as part of the input 701 or prompt. RAG may be used to enhance the input to the LLM/VLM/MMLM/etc. with external knowledge, so that answers to specific questions or queries or requests are more relevant-such as in a case where specific knowledge is required. The RAG component 792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 701 may be generated using the query or input to the model (e.g., a question, a request, etc.) in addition to data retrieved using the RAG component 792. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve-using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history- or at least a summary thereof- and include the prior conversation history along with the current ask/request as part of the input 701 to the generative LM 730.

The RAG component 792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 792 and the embeddings of the chunks along with the embeddings of the query may be compared to identify the most similar/related embeddings to the query, which may be supplied to the generative LM 730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents-which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data/video data/etc., the input processor 701 may resize the data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 701 may resample an audio file to a consistent sampling rate for uniform processing, and the embedding component 720 may use any known technique to extract and encode audio features-such as in the form of a spectrogram (e.g., a mel-spectrogram). In some implementations in which the input 701 includes video data, the input processor 701 may extract frames or apply resizing to extracted frames, and the embedding component 720 may extract features such as optical flow embeddings or video embeddings and/or may encode temporal information or sequences of frames. In some implementations in which the input 701 includes multi-modal data, the embedding component 720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 730 and/or other components of the generative LM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 720 may apply an encoded representation of the input 701 to the generative LM 730, and the generative LM 730 may process the encoded representation of the input 701 to generate an output 790, which may include responsive text and/or other types of data.

As described herein, in some embodiments, the generative LM 730 may be configured to access or use- or capable of accessing or using-plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated —e.g., recursively—for any number of iterations and using any number of plug-ins/APIs 795 until an output 790 that addresses each ask/question/request/process/operation/etc. from the input 701 can be generated. As such, the model(s) may not only rely on its own knowledge from training on a large dataset(s) and/or from data retrieved using the RAG component 792, but also on the expertise or optimized nature of one or more external resources-such as the plug-ins/APIs 795.

In some embodiments, one or more transformer engines (TEs) may be implemented. The transformer engine may use micro-tensor scaling to optimize performance and accuracy-such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices-such as GPUs—to provide better performance with lower memory utilization in both training and inference. When the TE is combined with other technologies, such as high-speed interconnects between nodes (e.g., using switches-such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 97A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 740 may convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 may generate a first token, and the generation mechanism 755 may apply the generated token as an input during a second pass. The process may repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 may output some decoded (e.g., vector) representation of the input being applied during a particular pass. The classifier 750 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 may select or sample a word or token based on a corresponding predicted probability (e.g., select the word with the highest predicted probability) and append it to the output from a previous pass, generating each word or token sequentially. The generation mechanism 755 may repeat the process, triggering successive decoder inputs and corresponding predictions until selecting or sampling a symbol or token that represents the end of the response, at which point, the generation mechanism 755 may output the generated response.

FIG. 7C is a block diagram of an example implementation in which the generative LM 730 includes a decoder-only transformer architecture. For example, the decoder(s) 760 of FIG. 7C may operate similarly as the decoder(s) 745 of FIG. 7B except each of the decoder(s) 760 of FIG. 7C omits the encoder-decoder self-attention layer (since there is no encoder in this implementation). As such, the decoder(s) 760 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 760. As with the decoder(s) 745 of FIG. 7B, each token (e.g., word) may flow through a separate path in the decoder(s) 760, and the decoder(s) 760, a classifier 765, and a generation mechanism 770 may use auto-regression to sequentially generate one token at a time until predicting a symbol or token that represents the end of the response. The classifier 765 and the generation mechanism 770 may operate similarly as the classifier 750 and the generation mechanism 755 of FIG. 7B, with the generation mechanism 770 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiment of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Example Autonomous or Semi-Autonomous Machine

FIG. 10A is an example of sensor locations having corresponding fields of view or sensory fields for an autonomous or semi-autonomous vehicle 1000a, an autonomous mobile robot (AMR) 1000b, and a humanoid robot 1000c, in accordance with some embodiments of the present disclosure. Although three types of machines 1000 are illustrated, this is not intended to be limiting, and the machine(s) 1000 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 1000a, AMR 1000b, humanoid robot 1000c, and/or other machine types may be referred to herein collectively as machine 1000, in some instances.

With respect to vehicles 1000A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 1000 may be capable of functionality in accordance with one or more of Level 3-Level 5 of the autonomous driving levels. The machine 1000 may be capable of functionality in accordance with one or more of Level 1-Level 5 of the autonomous driving levels. For example, the machine 1000 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 1000 or other machine, such as being fully autonomous, being highly autonomous, being conditionally autonomous, being partially autonomous, providing assistive autonomy, being semi-autonomous, being primarily autonomous, or other designation.

With respect to FIG. 10A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 1068D, a 180 degree field of view of a wide-view camera 1070, a 360 degree sensory field of a LiDAR sensor 1064, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 1000a, AMR 1000b, and/or humanoid robot 1000c, etc. For example, with respect to the vehicle 1000a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 1000b and/or humanoid robot 1000c, the shape, size, purpose, implementation, model, etc. may dictate the number and types of sensors used.

As illustrated in FIG. 1A, the autonomous or semi-autonomous vehicle 1000A, the AMR 1000B, and the humanoid robot 1000C may include different sensor types, number, and locations. For a non-limiting example, the vehicle 1000A may include twelve cameras 1064, such as a front wide camera (e.g., 120 degree field of view (FOV)), a front telephoto camera (e.g., 30 degree fOV), a side rear left camera (e.g., 70 degree fOV), a side rear right camera (e.g., 70 degree fOV), a front fisheye camera (e.g., 200 degree fOV), a rear fisheye camera (e.g., 200 degree fOV), a left fisheye camera (e.g., 200 degree fOV), a right fisheye camera (e.g., 200 degree fOV), a front telephoto satellite camera (e.g., 30 degree fOV), a rear telephoto camera (e.g., 30 degree fOV), a cross left camera (e.g., 120 degree fOV), and a cross right camera (e.g., 120 degree fOV). The camera(s) 1064 may use, in embodiments, a gigabit multimedia serial link (GMSL) interface —such as GMSL2—as input/output (I/O).

In some embodiments, although not illustrated in FIG. 10A, the vehicle 1000A may include an in-cabin occupant and/or driver monitoring system, that may include various different sensors. For example, the in-cabin sensors may include various cameras 1068, such as a driver monitoring camera (e.g., 55 degree fOV positioned forward of and facing toward the driver seat), a front occupant monitoring camera (e.g., 190 degree fOV positioned forward of and facing the front occupant(s) seat(s)), and a rear occupant monitoring camera (e.g., 190 degrees positioned forward of and facing the rear occupant(s) seat(s)). Similar to the external facing camera(s) 1068, the internal camera(s) 1068 may, in embodiments, use a GMSL (such as GMSL2) interface for I/O.

As another non-limiting example, the vehicle 1000A may further include nine RADAR sensors 1060. For example, the vehicle 1000A may include a front center imaging RADAR sensor (e.g., 120 degree fOV or sensory field), a corner front left RADAR sensor (e.g., 160 degree fOV or sensory field), a corner front right RADAR sensor (e.g., 160 degree fOV or sensory field), a corner rear right RADAR sensor (e.g., 160 degree fOV or sensory field), a side left RADAR sensor (e.g., 160 degree fOV or sensory field), a side right RADAR sensor (e.g., 160 degree fOV or sensory field), a rear left RADAR sensor (e.g., 50 degree fOV or sensory field), and rear right RADAR sensor (e.g., 50 degree fOV or sensory field). The RADAR sensor(s) 1060 may use, in embodiments, an Ethernet interface as I/O.

The vehicle(s) 1000A may further include, as a non-limiting example, twelve ultrasonic sensors 1062. As illustrated in FIG. 10A, the ultrasonic sensors may be positioned along the front and rear bumpers of the vehicle 1000A, and along the side of the vehicle 1000A, and may be used to detect objects (static and dynamic) in close proximity to the vehicle 1000A. In some embodiments, the ultrasonic sensor(s) 1062 may use a DS13 interface as I/O.

The vehicle(s) 1000A may further include, as a non-limiting example, a LiDAR sensor 1064, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 1064 may include a 360 degree horizontal FOV or sensory field (such as in a spinning LiDAR sensor) and a 90 degree vertical FOV or sensory field. In some embodiment, the LiDAR sensor(s) 1064 may use an Ethernet interface as I/O.

The autonomous mobile robot (AMR) 1000B may include, as a non-limiting example, three LiDAR sensors 1064. For example, the top-most illustrated LiDAR sensor 1064 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 1000B may further include, as a non-limiting embodiment, eight cameras 1068, such as a front stereo camera (e.g., 120 degree fOV), a rear stereo camera (e.g., 120 degree fOV), a left stereo camera (e.g., 120 degree fOV), a right stereo camera (e.g., 120 degree fOV), a front fisheye camera (e.g., 202 degree+−3 degree fOV), a rear fisheye camera (e.g., 202 degree +−3 degree fOV), a left fisheye camera (e.g., 202 degree+−3 degree fOV), and a right fisheye camera (e.g., 202 degree+−3 degree fOV).

The AMR 1000B may further include a charging port, charging port contacts, a status indicator light, one or more (e.g., four) RGB LEDs, one or more IMU sensors 1066, a magnetometer, and a barometer. The AMR 1000B is capable of high-precision time synchronization between sensors using hardware time stamping, and PTP over Ethernet with less than 10 microseconds for sensor acquisition time. The AMR 1000B provides simultaneous camera capture across all cameras 1068 within 100 microseconds from a single hardware trigger, in embodiments, and can write to disk at 4 GB/second for sensor capture to bag writing (e.g., writing to ROSbags for the robot operation system (ROS)). As such, the AMR 1000B is capable of running the ROS (such as NVIDIA's Isaac ROS), can be teleoperated (as described herein), can map an environment, and can navigate within an environment using visual cameras 1068, LiDARs 1064, and/or other sensor types or modalities.

The humanoid robot 1000C may include, as a non-limiting example, one LiDAR sensor 1064. For example, the LiDAR sensor 1064 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 1000C may further include, as a non-limiting embodiment, four cameras 1068, such as a front stereo camera (e.g., 120 degree fOV), a rear stereo camera (e.g., 120 degree fOV), a front fisheye camera (e.g., 202 degree+−3 degree fOV), and a rear fisheye camera (e.g., 202 degree+−3 degree fOV).

The humanoid robot 1000C may further include, as a non-limiting embodiment, four ultrasonic sensors 1062, such as a left arm ultrasonic sensor, a right arm ultrasonic sensor, a left leg ultrasonic sensor, and right leg ultrasonic sensor.

The humanoid robot 1000C may further include any number of actuators-such as to allow control and maneuverability of joints. For example, the humanoid robot 1000C may include actuators that allow for various degrees of freedom (DoF) depending on the design. In a non-limiting embodiment, the humanoid robot 1000C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 1000C may include position and orientation sensors, such as encoders, gyroscopes, and the like, to determine the position of the robot 1000C in space, allowing for location determination and movement tracking. The humanoid robot 1000C may include force and pressure sensors, in embodiments, to detect environment interactions, allowing the robot 1000C to grasp objects with the right force and to avoid obstacles along the way. The perception sensors (e.g., cameras, LiDARs, RADARs, ultrasonic, SONAR, etc.) may be used along with tactile sensors to allow the robot 1000C to perceive objects, shapes, and textures, and to understand when touch is initiated and stopped (along with force sensors that regulate the force used during touch). As a non-limiting example, the humanoid robot 1000C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 1000C, in embodiments, may include a conversational system —such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 1000C may use onboard sensors, microphones, and speakers to understanding speech, audio and visual cues, etc., while also being able to communicate back to the environment.

With reference to cameras 1068 of the machine(s) 1000, the camera types for the cameras 1068 may include, but are not limited to, digital cameras that may be adapted for use with the components and/or systems of the machine 1000. For a vehicle 1000a implementation, the camera(s) 1068 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1068B that may be used to perceive objects coming into view from the periphery (e.g., pedestrians, warehouse vehicles, other robots, crossing traffic, or bicycles). In addition, any number of long-range camera(s) 1068E (e.g., a long-view stereo camera pair) may be used for depth-based object detection, especially for objects for which a neural network has not yet been trained. The long-range camera(s) 1068E may also be used for object detection and classification, as well as basic object tracking.

Any number of stereo cameras 1068A may also be included in a front-facing and/or other (e.g., rear-facing) configuration. In at least one embodiment, one or more of stereo camera(s) 1068A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 1000 environment, including a distance estimate for points in the image (e.g., a disparity or depth image). An alternative stereo camera(s) 1068A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 1000 (e.g., side-view cameras) may be used, for example, for surround view, providing information used to create and update the occupancy grid, as well as to generate side impact collision warnings and/or to indicate to an AMR 1000B or humanoid robot 1000C, for example, that there are objects, features, and/or persons present to the side. For example, surround camera(s) 1068D may be positioned on the machine 1000. The surround camera(s) 1068D may include wide-view camera(s) 1068B, fisheye camera(s), 360 degree camera(s), and/or the like. For example, four fisheye cameras may be positioned on the machine's 1000 front, rear, and sides. In an alternative arrangement, the machine 1000 may use three surround camera(s) 1068D (e.g., left, right, and rear), and may leverage one or more other camera(s) (e.g., a forward-facing camera) as a fourth surround view camera.

Cameras 1068 with a field of view that include portions of the environment to the rear of the machine 1000 (e.g., rear-view cameras) may be used for gaining an understanding of objects, features, persons, and/or other information to the rear of the machine 1000, such as for park assistance, surround view, rear collision warnings, planning, control, and navigation determinations, and/or creating and updating an occupancy grid, BEV image representing the environment, height map, etc. A wide variety of cameras 1068 may be used including, but not limited to, cameras 1068 that are also suitable as a front-facing camera(s) (e.g., long-range and/or mid-range camera(s) 1068E, stereo camera(s) 1068A), infrared camera(s) 1068C, etc.), rear-facing camera(s), side-facing camera(s), downward facing camera(s), upward facing camera(s), and/or the like, as described herein.

Similarly, for LiDAR sensors 1064, RADAR sensors 1060, ultrasonic sensors 1062, and/or other sensor modalities or types, the location and placement of the sensors, and their corresponding fields of view or sensory fields may be determined based on the use case, implementation, or design of the particular machine 1000.

For example, the machine(s) 1000 include RADAR sensor(s) 1060 that may be used by the machine 1000 for long-range object detection, even in darkness and/or severe weather conditions. RADAR functional safety levels may be ASIL B, in embodiments. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250m range. The RADAR sensor(s) 1060 may help in distinguishing between static and moving objects, and may be used by ADAS systems for emergency brake assist and forward collision warning, by robots for detecting dynamic objects in various environments-such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 1000 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 1060m (front) or 80m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 1000 (e.g., vehicle, robot, etc.). As such, short-range RADAR systems may be used in an ADAS system for blind spot detection and/or lane change assist.

The machine 1000 may further include ultrasonic sensor(s) 1062. The ultrasonic sensor(s) 1062, which may be positioned at the front, back, and/or the sides of the machine 1000, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 1000. A wide variety of ultrasonic sensor(s) 1062 may be used, and different ultrasonic sensor(s) 1062 may be used for different ranges of detection (e.g., 2.5m, 4m). The ultrasonic sensor(s) 1062 may operate at functional safety levels of ASIL B, as an example.

The machine 1000 may include LiDAR sensor(s) 1064. The LiDAR sensor(s) 1064 may be used for object and feature detection, pedestrian and other robot detection, emergency braking, collision avoidance, simultaneous localization and mapping (SLAM), free-space detection, and/or other functions. The LiDAR sensor(s) 1064 may be functional safety level ASIL B, in embodiments. In some examples, the machine 1000 may include multiple LiDAR sensors 1064 (e.g., two, four, six, etc.) that may use Ethernet (e.g., to provide data to a Gigabit Ethernet switch).

In some examples, the LiDAR sensor(s) 1064 may be capable of providing a list of objects and their distances for a 360-degree field of view. Commercially available LiDAR sensor(s) 1064 may have an advertised range of approximately 1000m, with an accuracy of 2 cm-3 cm, and with support for a 1000 Mbps Ethernet connection, for example. In some examples, one or more non-protruding LiDAR sensors 1064 may be used. In such examples, the LiDAR sensor(s) 1064 may be implemented as a small device that may be embedded into the front, rear, sides, top, and/or corners of the machine 1000. The LiDAR sensor(s) 1064, in such examples, may provide up to a 120-degree horizontal and 35-degree vertical field-of-view, with a 200m range even for low-reflectivity objects. Front-mounted LiDAR sensor(s) 1064 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 1000. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1064 may be less susceptible to motion blur, vibration, and/or shock.

FIG. 10B is an illustration of sensor and component locations of an example autonomous or semi-autonomous vehicle 1000A (alternatively referred to herein as “vehicle 1000,” “ego-vehicle 1000,” “ego-machine 1000,” or “machine 1000,”), in accordance with some embodiments of the present disclosure. Although the vehicle 1000A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 10C is a block diagram of an example system architecture for a machine 1000, such as autonomous or semi-autonomous vehicle 1000A, autonomous mobile robot (AMR) 1000B, humanoid robot 1000C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises-such as locally hosted servers, remotely located-such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1000 of FIGS. 10A-10E, example computing ecosystem 1100 of FIG. 11, example generative language model system 700 of FIG. 7A, and/or example computing device 800 of FIG. 8.

Each of the components, features, and systems of the machine 1000 in FIG. 10C are illustrated as being connected via bus 1002 (alternatively referred to as a “machine communications network 1002,” or just “communications network 1002”). The bus 1002 may include a Controller Area Network (CAN) data interface (alternatively referred to herein as a “CAN bus”). A CAN may be a network inside the machine 1000 used to aid in control of various features and functionality of the machine 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 1002 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the machine 1000, and two or more busses 1002 may communicate with the same components. In some examples, each SoC 1004, each controller 1036, and/or each computer or compute engine within the machine 1000 may have access to the same input data (e.g., inputs from sensors of the machine 1000), and may be connected to a common bus, such as a CAN bus.

The machine 1000 may include components such as a chassis, a vehicle body, wheels (e.g., 2, 4, 6, 8, 18, etc.), tires, axles, batteries, side-view mirrors, and/or other components of a vehicle or machine. The machine 1000 may include a propulsion system 1050, such as an internal combustion engine, hybrid electric power plant, an all-electric engine, a hydrogen-fueled engine, and/or another propulsion system type. The propulsion system 1050 may be connected to a drive train of the machine 1000, which may include a transmission, to enable the propulsion of the machine 1000. The propulsion system 1050 may be controlled in response to receiving signals from the throttle/accelerator 1052.

A steering system 1054, which may include a steering wheel and/or other steering device (e.g., remote steering and/or local steering), may be used to steer the machine 1000 (e.g., along a desired path or route) when the propulsion system 1050 is operating (e.g., when the vehicle is in motion). The steering system 1054 may receive signals from a steering actuator 1056. In some embodiments, a steering wheel or other steering mechanism may not be included, such as for a machine 1000 capable of full automation (e.g., Level 5) functionality.

The brake sensor system6 may be used to operate the vehicle brakes in response to receiving signals from the brake actuators8 and/or brake sensors.

The machine 1000 may include one or more controller(s) 1036, such as those described herein with respect to FIG. 10A. The controller(s) 1036 may be used for a variety of functions, and may be coupled to any of the various other components and systems of the machine 1000. For example, the controllers 1036 may be used for control of the machine 1000, artificial intelligence executing on the machine 1000, infotainment for the machine 1000, and/or the like. For example, one controller 1036 may be used for some or all of the functionality, or different controllers 1036 may be used for different functionalities—e.g., to ensure availability and a safety separation between various controllers for different tasks. For example, the controller(s) 1036 may use plans computed by the system—e.g., paths or trajectories for vehicles 1000A or AMRs 1000B, or movements, components trajectories, movement locations or displacements, etc. for joints or components (e.g., of manipulators, end effectors, limbs, hands, fingers, legs, feet, etc.), of a humanoid robot 1000C—to control the machine(s) 1000 in the environment. In some instances, the controller(s) 1036 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 1000C, for example, the controller(s) 1036 may act as the brain, responsible for analyzing sensor data, making decisions, and sending commands to the actuators. The controller(s) 1036 may include a low-level controller that handles basic motor control, ensuring accurate and precise movements of individual joints and actuators. The controller(s) 1036 may include a high-level controller to coordinate multiple actuators and sensors, planning complex motions and adapting to changing environments.

The controller(s) 1036 may include an artificial intelligence controller, in embodiments, that may use AI algorithms (e.g., DNNs, MLMs, etc.) to learn, make decisions, and autonomously perform tasks for the machine 1000. In some embodiments, the controller(s) 1036 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 1036 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 1036, which may include one or more systems on chip (SoCs) 1004 (FIGS. 10C and 10D), CPUs, GPU(s), accelerator(s), etc., may provide signals (e.g., representative of commands or messages) to one or more components and/or systems of the machine 1000. Although the controller(s) 1036 is listed separately from the SoC(s) 1004, this is not intended to be limiting, and in some embodiments one or more components of the SoC(s) 1004 may perform the operations of the controller(s) 1036. For example, the controller(s) may send signals to operate the machine brakes via one or more brake actuators8, to operate the steering system 1054 via one or more steering actuators 1056, to operate the propulsion system 1050 via one or more throttle/accelerators 1052, etc. The controller(s) 1036 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 1000. The controller(s) 1036 may include a first controller 1036 for autonomous control and navigation functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 1036 may handle two or more of the above functionalities, two or more controllers 1036 may handle a single functionality, and/or any combination thereof.

The controller(s) 1036 may provide the signals for controlling one or more components and/or systems of the machine 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LiDAR sensor(s) 1064, inertial measurement unit (IMU) sensor(s) 1066 (e.g., accelerometer(s), gyroscope(s), magnetic compass(es), magnetometer(s), etc.), microphone(s) 1096, camera(s) 1068 (e.g., stereo camera(s) 1068A, wide-view camera(s) 1068B (e.g., fisheye cameras), infrared camera(s) 1068C, surround camera(s) 1068D (e.g., 360 degree cameras), long-range and/or mid-range camera(s) 1068E, and/or other camera types), speed sensor(s)4 (e.g., for measuring the speed of the machine 1000), vibration sensor(s)2, steering sensor(s)0, brake sensor(s) (e.g., as part of the brake sensor system6), actuators, and/or other sensor types.

One or more of the controller(s) 1036 may receive inputs (e.g., represented by input data) from an instrument cluster 1032 of the machine 1000 and provide outputs (e.g., represented by output data, display data, etc.) via a human-machine interface (HMI) display 1034 (e.g., screen, heads-up display, mirror display, facial display, robotic display, etc.), an audible annunciator, a loudspeaker, a speaker, and/or via other components of the machine 1000. The outputs may include information such as machine velocity, speed, time, map data corresponding to a map(s) 1022 of FIG. 10C (e.g., from a navigation map, a Standard Definition (SD) map, a High Definition (“HD”) map, etc.), location data (e.g., the machine's 1000 location, such as on a map 1022), direction, location of other vehicles (e.g., an occupancy map, height map, bird's eye view (BEV) image, grid, etc.), information about objects and status of objects as perceived by the system, system status information, etc. For example, the HMI display(s) 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 1000 may include one or more systems on a chip (SoCs) 1004 (described in more detail in FIG. 10D). The SoC(s) 1004 may include CPU(s) 1006, GPU(s) 1008, processor(s) 1010, cache(s) 1012, accelerator(s) 1014, data store(s) 1016, and/or other components and features. The SoC(s) 1004 may be used to process and provide data for various operations, such as navigation, planning, reasoning, inference, perception, control, and/or actuation operations of the machine 1000 in a variety of platforms and systems. For example, the SoC(s) 1004 may process live perception data (e.g., from camera, LiDAR, RADAR, ultrasonic, etc.) in addition to map data corresponding to one or more maps 1022 (e.g., HD map, SD map, navigational map, occupancy map, etc.) in order to make or aid in performing various operations of the machine 1000. Where a map and/or AI is used, map and/or AI (e.g., model parameter updates, fine-tuning, etc.) refreshes and/or updates via a network interface 1024 from one or more servers (e.g., server(s) 1078 of FIG. 10E)—such as one or more servers of a cloud-based data center.

Although an SoC(s) 1004 is illustrated throughout FIGS. 10A-10E, additional or alternative components and/or architectures may be used-such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 1000, use of the machine 1000, model of the machine 1000, and required capabilities of the machine 1000, one or more SoCs 1004 and/or alternative architectures and/or components may be used to satisfy the particular implementation.

The machine 1000 may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The machine 1000 may include a GPU(s) 1020 (e.g., discrete GPU(s), or dGPU(s)), that may be coupled to the SoC(s) 1004 via a high-speed interconnect (e.g., NVIDIA's NVLink). The GPU(s) 1020 may provide additional artificial intelligence functionality, such as by executing redundant and/or different neural networks, and may be used to train and/or update neural networks based on input (e.g., sensor data) from sensors of the machine 1000.

The machine 1000 may further include the network interface 1024 which may include one or more wireless antennas 1026 and/or modems (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 1000 information about vehicles in proximity to the machine 1000 (e.g., vehicles in front of, on the side of, and/or behind the machine 1000). This functionality may be part of a cooperative adaptive cruise control functionality of the machine 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The machine 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The machine 1000 may further include IMU sensor(s) 1066. The IMU sensor(s) 1066 may be located at a center of the rear axle of the machine 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the machine 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include one or more microphone 1096 placed in and/or around the machine 1000. The microphone(s) 1096 may be used for emergency vehicle detection and identification, among other things.

The machine 1000 may further include vibration sensor(s) 2. The vibration sensor(s) 2 may measure vibrations of components of the machine, such as the arms or legs of a humanoid robot 1000C, or the axle(s) of a vehicle 1000A or AMR 1000B. For example, changes in vibrations may indicate a change in road, walking, or traversable surfaces. In another example, when two or more vibration sensors2 are used, the differences between the vibrations may be used to determine friction or slippage of the surface (e.g., when the difference in vibration is between a power-driven axle and a freely rotating axle).

The machine 1000 may include an ADAS system 1038—such as when the machine 1000 is a vehicle 1000A. The ADAS system 1038 may include a dedicated SoC(s), in some examples. The ADAS system 1038 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 1000 may further include the infotainment SoC 1030 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the machine 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the machine 1000) fail. In such an example, the infotainment SoC 1030 may put the machine 1000 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models-such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 1000—whether a vehicle 1000A, AMR 1000B, humanoid robot 1000C, and/or other type of machine—may include a locally stored language model(s) and/or communicate to a remotely hosted language model (e.g., via one or more APIs) to provide more detailed and in-depth communication features to the users of the machine(s) 1000.

In some examples, an infotainment SoC 1030, the SoC(s), and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In some embodiments, an in-cabin monitoring camera sensor may be monitored using one or more neural networks running on another or dedicated SoC-such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 1000.

The machine 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a block diagram of an example architecture of a computing system (a subset of the system described with respect to FIG. 10C), in accordance with at least some embodiments of the present disclosure. Although illustrated as an SoC(s) 1004, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 1004 may be an end-to-end platform with a flexible architecture that spans automation levels 2-5, or the SoC(s) 1004 may be specifically designed for a specific automation level (e.g., a first SoC 1004 for level 2 to level 2++, a second SoC 1004 for level 3, a third SoC 1004 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 2-5 autonomous vehicles as well as for safe planning, navigation, and control of AMRs 1000B, humanoid robots 1000C, and/or other robot or machine types.

In some embodiments, such as where the SoC(s) 1004 include a GPU 1008 with 2000 or more cores (e.g., 2048 cores), 60 or more tensor cores (e.g., 64 tensor cores), and a GPU max frequency of over 1 GHz (e.g., 1.3 GHZ), a CPU 1006 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1009 (e.g., 2 DLAs/XNNs/NNAs/NPUs 1009), and a vision accelerator-such as a programmable vision accelerator (PVA) 1007, a single SoC 1004) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 1004 include a GPU 1008 with 1700 or more cores (e.g., 1792 cores), 50 or more tensor cores (e.g., 56 tensor cores), and a GPU max frequency of over 900 MHz (e.g., 930 MHz), a CPU 1006 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1009 (e.g., 2 DLAs/XNNs/NNAs/NPUs 1009), and a vision accelerator-such as a programmable vision accelerator (PVA) 1007, a single SoC 1004) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 1004 include a GPU 1008 with 1000 or more cores (e.g., 1024 cores), 28 or more tensor cores (e.g., 32 tensor cores), and a GPU max frequency of over 900 MHz (e.g., 1173 MHz), a CPU 1006 including 8 or more cores (e.g., 8 cores), with 64 bits, 2 MB L2 and 4 MB L3 cache memory, and a max frequency of 2 or more GHz (e.g., 2 GHZ), one or more deep learning accelerators (DLAs), deep learning accelerator clusters (XNNs), neural network accelerators (NNAs), or neural processing units (NPUs) 1009 (e.g., 1 DLA/XNN/NNA/NPU 1009), and a vision accelerator-such as a programmable vision accelerator (PVA) 1007, a single SoC 1004) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 1004 include a GPU 1008 with 1000 or more cores (e.g., 1024 cores), 28 or more tensor cores (e.g., 32 tensor cores), and a GPU max frequency of over 900 MHz (e.g., 1020 MHz), a CPU 1006 including 6 or more cores (e.g., 6 cores), with 64 bits, 1.5 MB L2 and 4 MB L3 cache memory, and a max frequency of 1.5 or more GHz (e.g., 1.7 GHZ), a single SoC 1004) may be capable of 67 tera operations per second (TOPS) of AI performance. For example, NVIDIA's Jetson Orin Nano 8 GB SoC satisfies these criteria, and achieves this performance.

The SoC(s) 1004 may include one or more CPUs 1006. The CPU(s) 1006 may include a CPU cluster or CPU complex (alternatively referred to herein as a “CCPLEX”), in embodiments. The CPU(s) 1006 may include multiple cores and/or (e.g., L2, L3) caches. For example, in some embodiments, the CPU(s) 1006 may include twelve cores in a coherent multi-processor configuration. In some embodiments, the CPU(s) 1006 may include four dual-core clusters where each cluster has a dedicated L2 cache (e.g., a 3 MB L2 cache). The CPU(s) 1006 (e.g., the CCPLEX) may be configured to support simultaneous cluster operation enabling any combination of the clusters of the CPU(s) 1006 to be active at any given time.

The SoC(s) 1004 may include any type and number of GPUs 1008. For example, an integrated GPU(s) (alternatively referred to herein as an “iGPU(s)”) may be used in some embodiments. The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive, robotics, and/or other embedded use cases. For example, the GPU(s) 1008 may be fabricated on a Fin field-effect transistor (FinFET). However, this is not intended to be limiting and the GPU(s) 1008 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

The SoC(s) 1004 may include any number of cache(s) 1012, including those described herein. For example, the cache(s) 1012 may include L0 caches, L1 caches, L2 caches, L3 caches (e.g., that are available to both the CPU(s) 1006 and the GPU(s) 1008 (e.g., that is connected both the CPU(s) 1006 and the GPU(s) 1008)), etc. The cache(s) 1012 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 1004 may include one or more arithmetic logic units (ALUs) 1065 which may be leveraged in performing processing with respect to any of the variety of tasks or operations of the machine 1000—such as computer vision, machine learning or deep learning processing, world model management, etc. In addition, the SoC(s) 1004 may include a floating point unit(s) (FPU(s)) 1067—or other math coprocessor or numeric coprocessor types—for performing mathematical operations within the system. For example, the SoC(s) may include one or more FPUs 1067 integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory 1015 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 1014 (e.g., the hardware acceleration cluster) may include a deep learning accelerator(s) (DLA) 1009 (alternatively referred to herein as “a deep learning accelerator cluster (XNN) 1009,” “neural network accelerator (NNA) 1009,” or “neural processing unit (NPU) 1009”). The DLA(s) 1009 may include one or more Tensor processing units (TPUs) 1 that may be configured to provide an additional, e.g., ten trillion operations per second for deep learning applications and inferencing. The TPUs1 may be accelerators configured to, and optimized for, performing image processing functions (e.g., for CNNs, RCNNs, DNNs, etc.). The DLA(s) 1009 may further be optimized for a specific set of neural network types and floating point operations, as well as inferencing. The design of the DLA(s) may provide more performance per millimeter than a general-purpose GPU, and vastly exceeds the performance of a CPU. The TPU(s) 1 may perform several functions, including a single-instance convolution function, supporting, for example, INT8, INT16, and FP16 data types for both features and weights, as well as post-processor functions. Although the TPU(s) 1 are described as being included as part of the DLA(s) 1009, this is not intended to be limiting, and the TPU(s) 1 may be included in additional or alternative accelerator(s) 1014 and/or other components, and/or may be included as a discrete processing component(s).

The DLA(s) 1009 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 1009 may perform any function of the GPU(s) 1008, and by using an inference accelerator, for example, a designer may target either the DLA(s) 1009 or the GPU(s) 1008 for any function. For example, the designer may focus processing of DNNs and floating point operations on the DLA(s) 1009 and leave other functions to the GPU(s) 1008 and/or other accelerator(s) 1014. The DLA(s) 1009 may be used to run any type of network to enhance control and safety, including for example, a neural network that outputs a measure of confidence for each object detection.

The accelerator(s) 1014 (e.g., the hardware acceleration cluster) may include a programmable vision accelerator(s) (PVA) 1007, which may alternatively be referred to herein as a computer vision accelerator or generally a vision accelerator. The PVA(s) 1007 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 1007 may provide a balance between performance and flexibility. For example, each PVA(s) 1007 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 1007 may be optimized for the tasks of image processing and computer vision algorithm acceleration. For example, the PVA(s) 1007 provides excellent performance with extremely low power consumption, and can be used asynchronously and concurrently with the CPU(s) 1006, GPU(s) 1008, and/or other accelerators in the system (e.g., vehicle, robot, etc.) as part of a heterogeneous compute pipeline.

The PVA(s) 1007 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP3 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts-ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 1006 (e.g., ARM Cortex-R5 processor), facilitating data exchange with the CPU(s) 1006 and other system-level components. The VPU I-cache may supply instruction data to the VPU(s) when requested, may request missing instruction data from system memory, and/or may maintain temporary instruction storage for the VPU. For each VPU task, the CPU(s) 1006 may configures the DMA system, optionally prefetch the VPU program into VPU I-cache, and/or kick off each VPU-DMA pair to process a task. The PVA(s) 1007 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 1007 to access the system memory independently of the CPU(s) 1006. The DMA may support any number of features used to provide optimization to the PVA(s) 1007 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 1007 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 1007, and may include one or more vector processing units (VPUs), one or more pixel processing engines (PPEs) —which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 1007 may be configured to employ data parallelism. For example, in some embodiments, the plurality of vector processors included in a single PVA(s) 1007 may execute the same computer vision algorithm, but on different regions of an image. In other examples, the vector processors included in a particular PVA(s) 1007 may simultaneously execute different computer vision algorithms, on the same image, or even execute different algorithms on sequential images or portions of an image. Among other things, any number of PVAs 1007 may be included in the hardware acceleration cluster and any number of vector processors may be included in each of the PVAs. In addition, the PVA(s) 1007 may include additional error correcting code (ECC) memory, to enhance overall system safety.

The accelerator(s) 1014 (e.g., the hardware accelerator cluster) have a wide array of uses for autonomous and semi-autonomous machine control. The PVA(s) 1007 may be a programmable vision accelerator that may be used for key processing stages in perception, robotics understanding and reasoning, ADAS, semi-autonomous, and autonomous vehicles, etc. The PVA's 1007 capabilities are a good match for algorithmic domains needing predictable processing, at low power and low latency. In other words, the PVA(s) 1007 performs well on semi-dense or dense regular computation, even on small data sets, which need predictable run-times with low latency and low power. Thus, in the context of platforms for autonomous vehicles and robotics, the PVAs 1007 are designed to run classic computer vision algorithms, as they are efficient at object detection and operating on integer math.

For example, according to one embodiment of the technology, the PVA 1007 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 1007 may perform computer stereo vision function on inputs from two monocular cameras.

In some examples, the PVA(s) 1007 may be used to perform dense optical flow. According to process raw RADAR data (e.g., using a 4D Fast Fourier Transform) to provide Processed RADAR. In other examples, the PVA(s) 1007 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 1007, this is not intended to be limiting. In some embodiments, these components may be included in alternative or additional processing components and/or accelerator(s) 1014, and/or may be included as discrete components of the SoC(s) 1004 and/or other computing system architecture(s).

In some examples, the SoC(s) 1004 may include a real-time ray-tracing hardware accelerator (RTA) 1051 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 1000 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 1051 and/or a ray-tracing optimized GPU 1006—such as NVIDIA's RTX GPU.

The accelerator(s) 1014 (e.g., in the hardware acceleration cluster) may include one or more optical flow accelerators (OFAs) 1011. For example, the OFA(s) 1011 may be used for computing optical flow and stereo disparity between frames of sensor data (e.g., images). Optical flow may be accelerated on the OFA(s) 1011 for uses such as object detection and tracking, and/or for stereo depth estimation where used for computing stereo disparity between stereo image frames (e.g., two or more frames captured using two or more image sensors with at least partially overlapping fields of view).

The SoC(s) 1004 may include one or more camera serial interfaces (CSIs) 1023. For example, the CSI(s) 1023 may include a mobile industry processor interface (MIPI) camera serial interface (CSI) for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role. For example, the CSI 1023 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2×MIPI CSI-2, 22 pin camera connector, depending on the embodiment and implementation.

The accelerator(s) 1014 (e.g., the hardware acceleration cluster) may include a computer vision network on-chip (CVNOC) 1063 and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by the PVA 1007, OFA 1011, DLA 1009, and/or other accelerator(s) 1014. Each pair of memory blocks may include an advanced peripheral bus (APB) interface, configuration circuitry, a controller, and a multiplexer. Any type of memory 1015 may be used. The PVA 1007, OFA 1011, DLA 1009, and/or other accelerator(s) 1014 may access the memory via a backbone that provides the accelerator(s) 1014 with high-speed access to memory. The backbone may include a computer vision network on-chip that interconnects the accelerator(s) 1014 to the memory (e.g., using the APB).

The CVNOC 1063 may include an interface that determines, before transmission of any control signal/address/data, that the accelerator(s) 1014 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 1004 may include data store(s) 1016 and/or memory 1015. The data store(s) 1016 may be on-chip memory 1015 of the SoC(s) 1004, which may store neural networks and/or other algorithms to be executed on the CPU(s) 1006, the GPU(s) 1008, and/or one or more of the accelerator(s) 1014. In some examples, the data store(s) 1016 may be large enough in capacity to store multiple instances of neural networks for redundancy and safety. The data store(s) 1012 may comprise L2 and/or L3 cache(s) 1012, for example. The memory(ies) 1015 may include SRAM, LPDDR5, and/or other memory types. For example, the memory(ies) 1015 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 1016 may include reference to the memory associated with the PVA 1007, OFA 1011, DLA 1009, and/or other accelerator(s) 1014, as described herein.

The data store(s) 1016 may include various storage types, such as eMMC, NVMe, etc. For example, the SoC(s) 1004 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 1016 and/or other storage may be accessed via, e.g., NVMe, using PCI Express (PCIe), RDMA, TCP, and/or other protocols.

The SoC(s) 1004 may include one or more processor(s) 1010 (e.g., embedded processors). The processor(s) 1010 may include a boot and power management processor (BPMP) 1053, that may be a dedicated processor and subsystem to handle boot power and management functions and related security enforcement. The BPMP 1053 may be a part of the SoC(s) 1004 boot sequence and may provide runtime power management services. The BPMP 1053 may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, accelerator(s) 1014, and/or other components. If temperatures are determined to exceed a threshold, BPMP 1053 may enter a temperature fault routine and put the SoC(s) 1004 into a lower power state and/or put the machine 1000 into a chauffeur to safe stop mode (e.g., bring the machine 1000 to a safe stop).

The processor(s) 1010 may further include a set of embedded processors that may serve as an audio processing engine (APE) 1055. The APE 1055 may be an audio subsystem that enables full hardware support for multi-channel audio over multiple interfaces, and a broad and flexible range of audio I/O interfaces. In some examples, the APE 1055 is a dedicated processor core with a digital signal processor with dedicated RAM.

The processor(s) 1010 may further include an always on processor engine (AOPE) 1057 that may provide necessary hardware features to support low power sensor management and wake use cases. The AOPE 1057 may include a processor core, a tightly coupled RAM, supporting peripherals (e.g., timers and interrupt controllers), various I/O controller peripherals, and routing logic.

The processor(s) 1010 may further include a safety processor(s) 1013 (alternatively referred to as “safety island 1013”), which may include a safety cluster engine that includes a dedicated processor or processor subsystem to handle safety management for automotive, robotics, and/or other applications. The safety processor(s) 1013—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 1013 may include a discrete processor(s), such that fault of other system components may not impact the performance and availability of the safety processor 1013.

The processor(s) 1010 may further include a real-time or near real-time sensor engine (SE) 1059 that may include a dedicated processor subsystem for handling real-time or near real-time camera, LiDAR, RADAR, and/or other sensor modality management.

The processor(s) 1010 may further include one or more image signal processors (ISPs) 1027, which may include a high-dynamic range signal processor and/or a hardware engine that is part of one or more sensor processing pipelines.

The processor(s) 1010 may include a video image compositor (VIC) 1061 that may be a processing block (e.g., implemented on a microprocessor) that implements video post-processing functions needed by a video playback application to produce the final image for the player window. The VIC 1061 may perform lens distortion correction on wide-view camera(s) 1068B, surround camera(s) 1068D, in-cabin monitoring camera sensors, and/or other camera sensors with distorted fields of view.

A VIC 1061 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 1061 may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a broad range of peripheral interfaces for input/output (I/O) 1025, such as to enable communication with peripherals, audio codecs, power management, and/or other devices. The SoC(s) 1004 may be used to process data from cameras (e.g., connected over Gigabit Multimedia Serial Link and/or Ethernet), sensors (e.g., LiDAR sensor(s) 1064, RADAR sensor(s) 1060, etc. that may be connected over Ethernet), data from bus 1002 (e.g., speed of machine 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks. In some embodiments, the SoC(s) 1004 I/O 1025 may include a header (e.g., a 40 pin header, or 40 pin expansion header) with support for universal asynchronous receiver/transmitter (UART), serial peripheral interface (SPI), inter-integrated circuit sound (I2S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 1025 elements, components, or features.

The SoC(s) 1004 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 1004 may include an RJ45 connector with up to 10 GbE, a 1 GbE connector, and/or other networking connector types.

The SoC(s) may include one or more digital signal processors (DSPs) 3. For example, the DSP(s) 3 may include a dedicated or specialized microprocessor chip optimized for digital signal processing-such as in audio signal processing, telecommunications, digital image processing, RADAR, SONAR, LiDAR, and/or other sensor processing, speech recognition, and/or other applications.

The SoC(s) 1004 may include one or more video encoders 1019 and/or one or more video decoders 1021. For example, the video encoder(s) 1019 may include a hardware-based (e.g., as part of the GPU(s) 1008) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 1021 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 1021 may be hardware-based (e.g., as part of the GPU(s) 1008).

The SoC(s) 1004 may include one or more general compute acceleration clusters (GCAC(s)) 1029. For example, the GCAC(s) 1029 may include various processor types that may be used to accelerate compute, such as one or more vector microcode processors (VMPs) 1033, one or more multi-threaded processing clusters (MPCs) 1031, one or more programmable macro arrays (PMA(s)) 1035, and/or one or more other processor types. For example, the GCAC(s) 1029 may include a PMA 1035, two VMPs 1033, and 2 MPCs 1031.

The SoC(s) 1004 may include one or more vector microcode processors (VMPs) 1033. The VMP(s) 1033, in embodiments, may include a wide vector (very long instruction word (VLIW) and single instruction multiple data (SIMD)) machine with performing various operations, such as short integral type operations common in computer vision and deep learning algorithms.

The SoC(s) 1004 may include one or more multi-threaded processing clusters (MPCs) 1031. The MPC(s) 1031 may include a processing cluster that be, in embodiments, more versatile than a GPU, and with higher efficiency than a CPU. For example, the MPC(s) 1031 may include a multi-threaded processor that allows multiple threads to share resources and execute instructions concurrently.

The SoC(s) 1004 may include one or more programmable macro arrays (PMA(s)) 1035. The PMA(s) 1035 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 1004 may include one or more display processing units (DPUs) 5 for performing hardware-accelerated image processing. For example, the DPU(s) 5 may retrieve pixel data from memory 1015 and send it to a display peripheral through standard interfaces. As such, the DPU(s) 5 may handle display processing and rendering for in-machine and/or on-machine displays.

The SoC(s) 1004 may include one or more application processing units (APUs) 1039. For example, the APU(s) 1039 may include a quad or dual-core processor with 48 KB/32 KB L1 cache with parity and ECC, along with a 1 MB L2 cache with ECC. The APU(s) 1039 may support NEON instructions and single and double precision floating point operations.

The SoC(s) 1004 may include one or more real-time processing units (RTPUs) 1069. The RTPU(s) 1069 may include a dual-core processor with 32 KB/32 KB L1 cache, and 256 KB TCM with ECC. The RTPU(s) 1069 may support single and double precision floating point operations.

The SoC(s) 1004 may include one or more built-in self-test (BIST) components 1037. For example, the BIST component(s) 1037 may include memory BIST (MBIST) to test memories of the system and/or logic BIST (LBIST) to test logic of the system. The BIST components 1037 may include embedded logic for directly testing logic and/or memory of the system.

The SoC(s) 1004 may include one or more dynamically reconfigurable processors (DRPs) 1071. For example, the DRP(s) 1071 may be used for accelerating various computing operations. For example, the DRP(s) 1071 may be combined, in embodiments, with a MAC unit for use as an AI accelerator. In embodiments, the DRP(s) 1071 may execute applications while dynamically switching the circuit connection configuration of the arithmetic units (e.g., ALUs) on the chip at each operating clock according to the content to be processed. Since only the necessary arithmetic circuits are used, the DRP(s) 1071 may consume less power than with CPU processing and can achieve higher speed. Furthermore, compared to CPUs, where frequent external memory accesses due to cache misses and other causes will degrade performance, the DRP(s) 1071 can build the necessary data paths in hardware ahead of time, resulting in less performance degradation and less variation in operating speed (jitter) due to memory accesses. The DRP(s) 1071 may include a dynamic loading function that switches the circuit connection information each time the algorithm changes, enabling processing with limited hardware resources, even in robotic/automotive applications that require processing of multiple algorithms.

In some embodiments, the accelerator(s) 1014 may include an OpenCV accelerator for speeding up processing of OpenCV, an open-source industry standard library for computer vision processing. In some embodiments, the combination of one or more DRP(s) 1071 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 1004 may include various compute engines (e.g., processors 1010, CPUs 1006, GPU(s) 1008, accelerator(s) 1014, etc.), tasks may be distributed between and among the compute engines, in some instances without common cause failures due to the discrete footprint of the compute engines. Further, because the SoC(s) 1004 may include a dedicated safety processor(s) 1013 (or safety island 1013), critical safety or redundant operations may be performed without common cause failures from the main processing components or compute engines of the SoC(s) 1014. Due to these features, the SoC(s) 1004 and/or the underlying systems of the machine 1000 may be capable of satisfying higher levels of safety-such as automotive safety integrity level (ASIL) D from the ISO 26262 standard.

FIG. 10E is a system diagram for communication between a cloud-based server(s) (e.g., in a data center, such as those described herein) and the example autonomous or semi-autonomous vehicle or machine 1000 of FIG. 10A, in accordance with some embodiments of the present disclosure. The system 1076 may include a server(s) 1078, a network(s) 1090, and a machine(s) 1000. The server(s) 1078 may include a plurality of GPUs 1084(A)—1084(H) (collectively referred to herein as GPUs 1084), switches 1082(A)-1082(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 1080(A)-1080(B) (collectively referred to herein as CPUs 1080), accelerators, and/or other processor types. The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the machine(s) 1000, sensor data indicating information about new or previously unexplored locations, and/or sensor data indicating changes to previously seen/stored locations (e.g., unexpected or changed road conditions, such as recently commenced road-work). The server(s) 1078 may transmit, over the network(s) 1090 and to the machine(s) 1000, neural networks 1092, updated neural networks 1092, map information 1094, etc., including information regarding traffic and road conditions. The updates to the map information 1094 may include updates for the HD map 1022, SD map, navigation map, etc., such as information regarding construction sites, potholes, detours, flooding, and/or other obstructions. In some examples, the neural networks 1092, the updated neural networks 1092, the map information 1094, and/or the other information may have resulted from new training and/or experiences represented in data received from any number of machine(s) 1000 in the environment, and/or based on training performed at a datacenter (e.g., using the server(s) 1078 and/or other servers).

The server(s) 1078 may be used to train machine learning models (e.g., neural networks) based on training data. The training data may be generated by the machine(s) 1000, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 1000 (e.g., transmitted to the machine(s) 1000 over the network(s) 1090, and/or the machine learning models may be used by the server(s) 1078 to remotely monitor and/or control the machine(s) 1000.

In some examples, the server(s) 1078 may receive data from the machine(s) 1000 and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the machine 1000. For example, the deep-learning infrastructure may receive periodic updates from the machine 1000, such as a sequence of images and/or objects that the machine 1000 has located in that sequence of images (e.g., via computer vision and/or other machine learning object classification techniques). The deep-learning infrastructure may run its own neural network to identify the objects and compare them with the objects identified by the machine 1000 and, if the results do not match and the infrastructure concludes that the AI in the machine 1000 is malfunctioning, the server(s) 1078 may transmit a signal to the machine 1000 instructing a fail-safe computer of the machine 1000 to assume control, notify the passengers, and complete a safety maneuver or operation-such as to slow down, hand control back to a driver, come to a stop, and/or pull over/shut down.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 11 is a system diagram illustrating a three computer ecosystem 1100, including a first computing system 1102 for generating or creating artificial intelligence (AI)—such as AI training and validation data, a second computing system 1104 for training artificial intelligence, and a third computing system 1106 (which may include or correspond to the SoC(s) 1004 of FIGS. 10A-10E) deploying the AI at the edge, in accordance with at least some embodiments of the present disclosure. For example, to develop and deploy embodied or physical AI, the three computer ecosystem 1100 may be used, including three accelerated computer systems to handle physical AI training, simulation, and runtime (e.g., edge deployment). These systems may generate training data for and train multimodal foundation models (and/or other model types) using scalable, physically based simulations of the machine(s) 1000 and their worlds. By doing so, simulation of machine(s) 1000 may be performed at scale, allowing for refinement, testing, and optimization of skills (e.g., robot skills) in a virtual world (e.g., using NVIDIA's OMNIVERSE) that mimics the laws of physics-helping to reduce real-world data acquisition costs and ensuring the machine(s) 1000 can perform safely in controlled settings.

The computing system 1104 (e.g., NVIDIA's DGX Platform) may be used to train and fine-tune powerful foundation and generative AI models. Models, such as general purpose foundation models (e.g., NVIDIA's Project GROOT), may be used to enable robots and other machine(s) 1000 to understand natural language and emulate movements by observing human actions. The computing system 1104 may include a platform that incorporates software, infrastructure, and expertise in a modern, unified AI development and training solution. The computing system 1104 may include individual computing devices 1110 (e.g., NVIDIA's DGX B200, H200, etc.) and/or any number of computing devices 1110 in a data center infrastructure 1112 (e.g., NVIDIA's DGX SuperPOD).

For example, the individual computing devices 1110 may include GPUs (e.g., 8 GPUs with 1,440 GB total GPU memory) and CPUs (e.g., 2 CPUs with 112 cores total, 2.1 GHZ, or 4 GHz (with boost)) that provide upwards of 72 petaFLOPS for training and 144 petaFLOPS for inference. The computing devices 1110 may include memory (e.g., 4 TB memory, and storage (e.g., OS storage of 2×1.9 TB NVMe M.2, and internal storage of 8×3.84 TB NVMe U.2). The computing devices 1110 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 1110 may further include, e.g., dual port quad small form-factor pluggable (QSFFP) data processing units (DPUs) (e.g., 2 dual-port QSFP112 DPUs-such as NVIDIA's BlueField-3 DPUs), providing up to 400 Gb/s InfiniBand/Ethernet. The computing device(s) 1110 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 1110 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1110 may include a smart host channel adapter (HCA) (e.g., NVIDIA's ConnectX-7) to provide ultra-low latency, 400 Gb/s throughput for in-network computing acceleration engines.

The data center infrastructure 1112 may include any number of the computing devices 1110, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 1110) to thousands, job scheduling and orchestration to ensure hassle-free execution of every developer's job, AI workflow management and machine learning operations (MLOps) to move more models from prototype to production, and enterprise software to speed developer success.

The computing system 1102 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 1102 allows developers to use simulation frameworks to simulate and validate robot models, and/or to generate massive amounts of physically-based synthetic data to bootstrap model training. The computing system 1102 may support learning frameworks that power robot reinforcement learning and imitation learning, to accelerate robot policy training and refinement. For example, the computing system 1102 may be used to generate any number of simulations 1108—such as within NVIDIA's OMNIVERSE. The computing system 1102 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 1102 may host or support a native OpenUSD software platform enabling enterprises to connect 3D pipelines and develop advanced, real-time 3D applications for industrial digitalization. With powerful ray-tracing-accelerated AI and graphics capabilities, the computing system 1102 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 1102 may include individual computing devices 1114 (e.g., NVIDIA's OVX L40S Server) and/or any number of computing devices 1114 in a data center infrastructure 1116 (e.g., NVIDIA's OVX Systems).

The computing device(s) 1114 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16:64 GB/s bidirectional interconnect interface, 18,176 CUDA cores, 142 ray tracing (RT) cores, and 568 tensor cores). The computing devices 1114 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs-such as an NVIDIA BlueField-3 DPU), providing up to 400 Gb/s InfiniBand/Ethernet. In some embodiments, the NICs used for the computing device(s) 1114 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1114 may include a smart host channel adapter (HCA) (e.g., NVIDIA's ConnectX-7) to provide ultra-low latency, 400 Gb/s throughput for in-network computing acceleration engines. The computing device(s) 1114 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 1112, the data center infrastructure 1116 may allow for any number of computing device(s) 1114 to be combined in cluster configuration according to a reference architecture.

The computing system 1106 may be used to deploy trained AI models on a runtime computer-such as the SoC(s) 1004 described herein. For example, these computing systems 1106 may be designed for compact, on-board computing needs, including an ensemble of models for control policy, vision and language models, etc., deployed on a power-efficient on-board edge computing system 1106. Details of components, features, and capabilities of the computing system 1106 may be described in more detail herein with respect to FIGS. 10A-10E.

FIG. 10F is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward-facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 1070 that may be used to perceive objects coming into view from the periphery (e.g., pedestrians, crossing traffic or bicycles). Although only one wide-view camera is illustrated in FIG. 10F, there may any number of wide-view cameras 1070 on the vehicle 1000. In addition, long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

One or more stereo cameras 1068 may also be included in a front-facing configuration. The stereo camera(s) 1068 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10F) may be positioned to on the vehicle 1000. The surround camera(s) 1074 may include wide-view camera(s) 1070, fisheye camera(s), 360-degree camera(s), and/or the like. For example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround-view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

### Example Clauses

### Example 1. A Method Comprising

generating, at least by populating one or more prompt templates based at least on program information that describes a software program, one or more generative language model (GLM) prompts related to fuzz testing the software program, the one or more GLM prompts to cause one or more GLMs to identify one or more functions of the software program and to generate a test harness for executing the fuzz testing based at least on the one or more functions as identified;
generating the test harness by providing the one or more GLM prompts to the one or more GLMs;
performing the fuzz testing of based at least on the test harness; and
causing presentation, one of visually or audibly, of results of the fuzz testing within a graphical user interface (GUI).

The method of example 1, wherein the generating of the one or more GLM prompts includes generating a function identification prompt corresponding to identification of the one or more functions based at least on one or more vulnerability metrics; and one or more outputs of the GLM include a target function output that is based at least on the function identification prompt and that identifies the one or more functions.

The method of example 1, wherein the generating of the one or more GLM prompts includes generating a test harness prompt based at least on one or more characteristics of the one or more functions; and one or more outputs of the GLM include a test harness output that includes the fuzzing code.

The method of example 1, wherein the test harness is obtained after multiple iterations of test harness outputs of the GLM based at least on multiple test harness prompts.

The method of example 1, wherein one or more iterations of the multiple iterations are based at least on one or more versions of fuzzing code of the test harness failing to compile.

The method of example 1, further comprising generating one or more fuzzing input seeds that are provided to the test harness as initial inputs for executing the fuzz testing.

The method of example 1, further comprising modifying the test harness based at least on one or more additional GLM outputs corresponding to one or more additional GLM prompts, the one or more additional GLM prompts being based at least on an evaluated performance of the fuzz testing.

### Example 2. A System Comprising

one or more processors to perform operations comprising:

generating, using one or more prompt templates, one or more generative language model (GLM) prompts related to fuzz testing a software program, the one or more GLM prompts to cause one or more GLM's to generate a test harness that includes fuzzing code for executing the fuzz testing of the software program as identified;
generating the test harness using the one or more GLM prompts and the one or more GLMs; and
performing the fuzz testing of the software program based at least on the test harness.

The system of example 2, wherein the one or more prompts are further to cause the one or more GLMs to identify one or more functions of the software program to target for the fuzz testing and wherein the test harness is generated based at least on the one or more functions.

The system of example 2, wherein the generating of the one or more GLM prompts includes generating a function identification prompt corresponding to identification of the one or more functions based at least on one or more vulnerability metrics; and one or more outputs of the GLM include a target function output that is based at least on the function identification prompt and that identifies the one or more functions.

The system of example 2, wherein the generating of the one or more GLM prompts includes generating a test harness prompt based at least on one or more characteristics of one or more functions of the software program; and one or more outputs of the GLM include a test harness output that includes the fuzzing code.

The system of example 2, further comprising verifying the test harness based on whether the fuzzing code compiles.

The system of example 2, the operations further comprising generating one or more fuzzing input seeds that are provided to the test harness as initial inputs for executing the fuzz testing.

The system of example 2, the operations further comprising modifying the test harness based at least on one or more additional GLM prompts that are based at least on an evaluated performance of the fuzz testing.

The system of example 2, the operations further comprising generating one or more repair patches based at least on the fuzz testing.

The system of example 2, wherein at least one of the one or more repair patches is generated based at least on at least one additional GLM prompt.

The system of example 2, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

### Example 3. One or more processors comprising

processing circuitry to perform operations comprising:

generating, using one or more generative language models, a test harness related to fuzz testing a software program; and
performing the fuzz testing of the software program based at least on the test harness.

The one or more processers of example 3, wherein the generating of the test harness is based at least on one or more prompts provided to the one or more generative language models.

The one or more processers of example 3, wherein the test harness is generated based at least on one or more vulnerability metrics of the software program as provided to the one or more generative language models.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating, at least by populating one or more prompt templates based at least on program information that describes a software program, one or more generative language model (GLM) prompts related to fuzz testing the software program, the one or more GLM prompts to cause one or more GLMs to identify one or more functions of the software program and to generate a test harness for executing the fuzz testing based at least on the one or more functions as identified;
generating the test harness by providing the one or more GLM prompts to the one or more GLMs;
performing the fuzz testing of based at least on the test harness; and
causing presentation, one of visually or audibly, of results of the fuzz testing within a graphical user interface (GUI).

2. The method of claim 1, wherein:
the generating of the one or more GLM prompts includes generating a function identification prompt corresponding to identification of the one or more functions based at least on one or more vulnerability metrics; and
one or more outputs of the GLM include a target function output that is based at least on the function identification prompt and that identifies the one or more functions.

3. The method of claim 1, wherein:
the generating of the one or more GLM prompts includes generating a test harness prompt based at least on one or more characteristics of the one or more functions; and
one or more outputs of the GLM include a test harness output that includes the fuzzing code.

4. The method of claim 3, wherein the test harness is obtained after multiple iterations of test harness outputs of the GLM based at least on multiple test harness prompts.

5. The method of claim 4, wherein one or more iterations of the multiple iterations are based at least on one or more versions of fuzzing code of the test harness failing to compile.

6. The method of claim 1, further comprising generating one or more fuzzing input seeds that are provided to the test harness as initial inputs for executing the fuzz testing.

7. The method of claim 1, further comprising modifying the test harness based at least on one or more additional GLM outputs corresponding to one or more additional GLM prompts, the one or more additional GLM prompts being based at least on an evaluated performance of the fuzz testing.

8. A system comprising:
one or more processors to perform operations comprising:
generating, using one or more prompt templates, one or more generative language model (GLM) prompts related to fuzz testing a software program, the one or more GLM prompts to cause one or more GLM's to generate a test harness that includes fuzzing code for executing the fuzz testing of the software program as identified;
generating the test harness using the one or more GLM prompts and the one or more GLMs; and
performing the fuzz testing of the software program based at least on the test harness.

9. The system of claim 8, wherein the one or more prompts are further to cause the one or more GLMs to identify one or more functions of the software program to target for the fuzz testing and wherein the test harness is generated based at least on the one or more functions.

10. The system of claim 9, wherein:
the generating of the one or more GLM prompts includes generating a function identification prompt corresponding to identification of the one or more functions based at least on one or more vulnerability metrics; and
one or more outputs of the GLM include a target function output that is based at least on the function identification prompt and that identifies the one or more functions.

11. The system of claim 8, wherein:
the generating of the one or more GLM prompts includes generating a test harness prompt based at least on one or more characteristics of one or more functions of the software program; and
one or more outputs of the GLM include a test harness output that includes the fuzzing code.

12. The system of claim 8, further comprising verifying the test harness based on whether the fuzzing code compiles.

13. The system of claim 8, the operations further comprising generating one or more fuzzing input seeds that are provided to the test harness as initial inputs for executing the fuzz testing.

14. The system of claim 8, the operations further comprising modifying the test harness based at least on one or more additional GLM prompts that are based at least on an evaluated performance of the fuzz testing.

15. The system of claim 8, the operations further comprising generating one or more repair patches based at least on the fuzz testing.

16. The system of claim 15, wherein at least one of the one or more repair patches is generated based at least on at least one additional GLM prompt.

17. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

18. One or more processors comprising:
processing circuitry to perform operations comprising:
generating, using one or more generative language models, a test harness related to fuzz testing a software program; and
performing the fuzz testing of the software program based at least on the test harness.

19. The one or more processers of claim 18, wherein the generating of the test harness is based at least on one or more prompts provided to the one or more generative language models.

20. The one or more processers of claim 18, wherein the test harness is generated based at least on one or more vulnerability metrics of the software program as provided to the one or more generative language models.
